(19) United States
(12) Patent Application Publication
(10) Pub. No.: US 2016/0357960 A1
(43) Pub. Date: Dec. 8, 2016

(54) COMPUTER-READABLE STORAGE MEDIUM, ABNORMALITY DETECTION DEVICE, AND ABNORMALITY DETECTION METHOD

(71) Applicant: FUJITSU LIMITED, Kawasaki-shi (JP)

(72) Inventors: Hiroki Katoh, Kawasaki (JP); Michio Masuno, Yokohama (JP); Kazuhiro Hayashi, Kawasaki (JP); Hiroaki Takahashi, Yokohama (JP)

(73) Assignee: FUJITSU LIMITED, Kawasaki-shi (JP)

(21) Appl. No.: 15/168,641

(22) Filed: May 31, 2016

(30) Foreign Application Priority Data
Jun. 3, 2015 (JP) 2015-113385

(51) Int. Cl. G06F 21/55; H04L 29/06; G06F 21/56

(52) U.S. Cl. CPC G06F 21/552; G06F 21/566; H04L 63/0245

(57) ABSTRACT

A computer-readable medium which stores an abnormality detection program causes a computer to execute processes including detecting, when a work corresponding to a process on the computer has been executed, at least one event that is associated with the process on the computer, the at least one event including at least one first event which respectively occurs in response to at least one input for the process by using the input device and determining whether the work is abnormal or not based on whether the at least one detected event matches at least one stored event in a storage unit or not.

### CROSS-REFERENCE TO RELATED APPLICATION

This application is based upon and claims the benefit of priority of the prior Japanese Patent Application No. 2015-113385, filed on Jun. 3, 2015, the entire contents of which are incorporated herein by reference.

### FIELD

The embodiment discussed herein is related to a computer-readable storage medium, an abnormality detection device and an abnormality detection method.

### BACKGROUND

A person managing security in a business or an organization (hereinafter also referred to simply as a worker) not only performs detection, quarantine, and destruction of computer viruses according to a virus definition file, but also detects, may suppress spreading, and the like of activity by malware other than computer viruses.

Malware is a general term for software having malicious intent, including computer viruses. Specifically, malware infects a terminal (hereinafter, also referred to as a management target terminal) which is used by a business or an organization, for example, and performs activities in order to enable unauthorized access from outside.

Therefore, the worker not only detects the infection of a management target terminal by malware, but also preferably detects unauthorized access (hereinafter also referred to as an abnormal work) that uses the management target terminal (for example, Japanese Laid-open Patent Publication No. 2010-182019, International Publication Pamphlet No. WO 2006/035928, and Japanese National Publication of International Patent Application No. 2010-512035).

### SUMMARY

According to an aspect of the invention, a computer-readable medium which stores an abnormality detection program causes a computer to execute processes including detecting, when a work corresponding to a process on the computer has been executed, at least one event that is associated with the process on the computer, the at least one event including at least one first event which respectively occurs in response to at least one input for the process by using the input device and determining whether the work is abnormal or not based on whether the at least one detected event matches at least one stored event in a storage unit or not.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of the overall configuration of an information processing system;

FIG. 2 is an explanatory diagram of a specific example of a malware infection of a worker terminal;

FIG. 3 is an explanatory diagram of the hardware configuration of an information processing device;

FIG. 4 is a functional block diagram of the information processing device of FIG. 3;

FIG. 5 is a flowchart describing an outline of an abnormality detection process in a first embodiment;

FIG. 6 is a flowchart describing an outline of the abnormality detection process in the first embodiment;

FIG. 7 is a diagram describing an outline of the abnormality detection process in the first embodiment;

FIG. 8 is a flowchart describing the details of the abnormality detection process in the first embodiment;

FIG. 9 is a flowchart describing the details of the abnormality detection process in the first embodiment;

FIG. 10 is a flowchart describing the details of the abnormality detection process in the first embodiment;

FIG. 11 is a flowchart describing the details of the abnormality detection process in the first embodiment;

FIG. 12 is an explanatory diagram of specific examples of first events;

FIG. 13 is an explanatory diagram of specific examples of second events;

FIG. 14 is an explanatory diagram of specific examples of third events;

FIG. 15 is an explanatory diagram of specific examples of first correspondence information;

FIG. 16 is an explanatory diagram of specific examples of second correspondence information;

FIG. 17 is an explanatory diagram of specific examples of third correspondence information;

FIG. 18 is an explanatory diagram of specific examples of first work identification information;

FIG. 19 is an explanatory diagram of specific examples of first aggregated information;

FIG. 20 is a graph determining the information that is set in “bit string” of the first work identification information;

FIG. 21 is a graph determining the information that is set in “bit string” of the first work identification information;

FIG. 22 is an explanatory diagram of a specific example of the information that is set in “bit string” of the first work identification information;

FIG. 23 is an explanatory diagram of a specific example of second work identification information;

FIG. 24 is an explanatory diagram of a specific example of second aggregated information;

FIG. 25 is a graph determining the information that is set in “bit string” of the second work identification information;

FIG. 26 is a graph determining the information that is set in “bit string” of the second work identification information;

FIG. 27 is an explanatory diagram of a specific example of the bit string corresponding to the second work identification information;

FIG. 28 is an explanatory diagram of specific examples of third work identification information;

FIG. 29 is an explanatory diagram of specific examples of feature point information; and

FIG. 30 is an explanatory diagram of specific examples of correction coefficient information.

### DESCRIPTION OF EMBODIMENT

The worker performs detection of unauthorized access or the like in which the management target terminal is used by performing analysis of a log (hereinafter also referred to as an event log) which is output from the management target terminal.

However, it is preferable to save the logs relating to all access including logs relating to ordinary access in order to analyze the log which is output from the management target terminal. Therefore, the worker may save a large amount of logs in order to perform the detection of unauthorized access.

There is a case in which the analysis of such a large amount of logs takes an excessive amount of time. Therefore, in this case, the worker may be unable to perform the detection of unauthorized access in which the management target terminal is used in real time.

Therefore, an object of one aspect is to efficiently perform detection of an abnormal work.

Configuration of Information Processing System

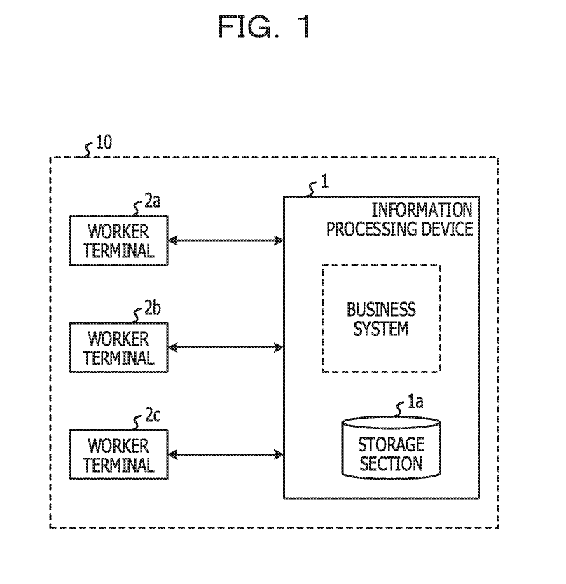

FIG. 1 is an explanatory diagram of the overall configuration of an information processing system 10. The information processing system 10 illustrated in FIG. 1 includes an information processing device 1 (hereinafter also referred to as a computer 1 or an abnormality detection device 1), worker terminals 2a, 2b, and 2c (hereinafter also referred to collectively as a worker terminal 2 or an input device 2).

For example, a business system (the dotted line portion of FIG. 1) constructed by a provider that provides a service to users operates in the information processing device 1. Specifically, the business system illustrated in FIG. 1 provides a service to a user by causing an application and an operating system (OS) to operate in cooperation, for example.

The worker terminal 2 is a terminal which may be operated by a worker. The worker carries out maintenance works or the like of the business system by accessing the information processing device 1 via the worker terminal 2. Specifically, the worker accesses the information processing device 1 and performs works such as acquiring operational information relating to the operation of the business system, and creation or deletion of files. Note that, the worker may perform maintenance works of the business system by directly operating the information processing device 1.

The information processing device 1 includes a storage section is for storing logs which are output accompanying the operations of the business system, for example. Specifically, the storage section 1a accumulates logs which are output from the business system in a case in which there is access to the information processing device 1, for example. The storage section is accumulates the logs which are output accompanying the operations of the application or the OS, each of which operates as a portion of the business system, for example.

Infection of Worker Terminal by Malware

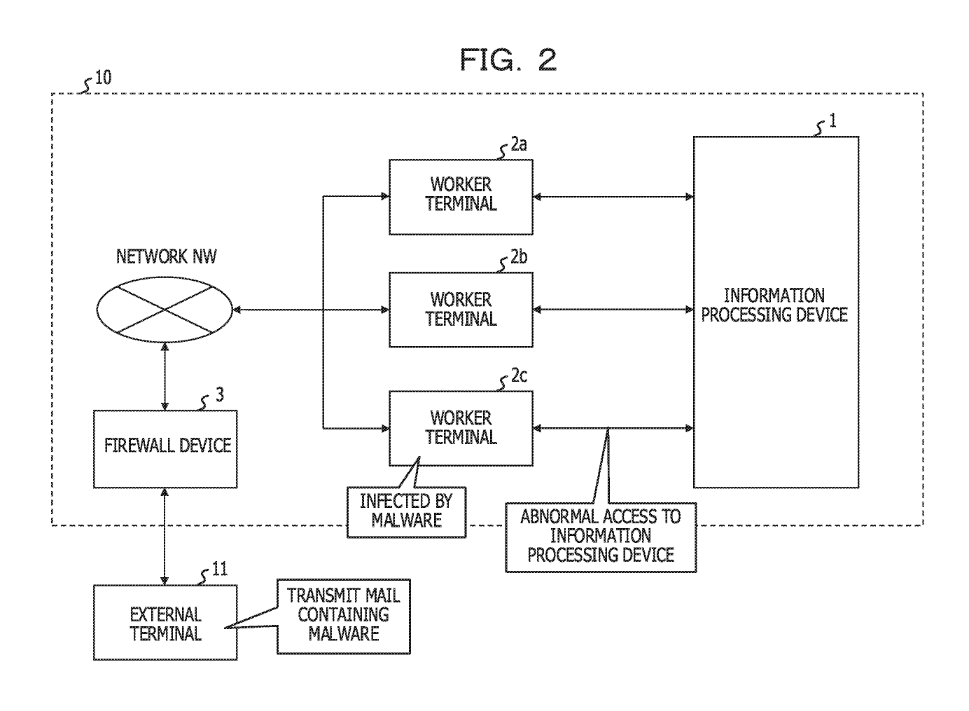

Next, description will be given of the infection of the worker terminal 2 by malware. FIG. 2 is an explanatory diagram of a specific example of a malware infection of the worker terminal 2.

In addition to the information processing device 1 and the worker terminal 2 illustrated in FIG. 1, the information processing system 10 illustrated in FIG. 2 includes a firewall device 3 which connects to the worker terminal 2 via a network NW (for example, the Internet).

The firewall device 3 is a device which limits access from an external terminal 11. Specifically, the firewall device 3 monitors the mail or the like which is transmitted from the external terminal 11, for example, and determines whether or not the mail or the like is infected with a virus such as malware. In a case in which the firewall device 3 determines that the mail or the like which is transmitted from the external terminal 11 is infected by a virus, the firewall device 3 discards the mail or the like without sending the mail or the like to the recipient (for example, the worker terminal 2 or the like) of the mail.

However, in recent years the number of types of malware is only accelerating, and examples exist which appear, at first glance, to pose no problem, such as malware included in an attached file of a mail. Therefore, there is a case in which the firewall device 3 may be unable to detect the malware that is attached to the mail which is transmitted from the external terminal 11, for example, and transmits the mail to the recipient (the worker terminal 2c in the example illustrated in FIG. 2) of the mail. In this case, the worker terminal 2c which receives the mail from the external terminal 11 is infected by the malware when, for example, the worker opens the file which is attached to the mail.

Subsequently, as illustrated in FIG. 2, the person (hereinafter also referred to as the attacker) that transmitted the mail to which the malware is attached uses the worker terminal 2c which is infected by the malware as a stepping stone to perform unauthorized access on the information processing device 1, for example. Accordingly, the attacker performs acquisition or the like of confidential information which is managed by the business system, for example.

Therefore, it is preferable that the worker performs the detection of the unauthorized access which is carried out on the information processing device 1, for example. Specifically, the worker performs analysis of the log (for example, the log relating to the access that is performed via the worker terminal 2) which is output to the storage section 1a. Accordingly, it becomes possible for the worker to detect that the information processing device 1 has been subjected to unauthorized access.

However, it is preferable that the worker saves the logs relating to all access including logs relating to ordinary access in order to analyze the log which is output from the information processing device 1. Therefore, the worker may save a large amount of logs in order to perform the detection of unauthorized access.

There is a case in which the analysis of such a large amount of logs takes an excessive amount of time. Therefore, in this case, the worker may be unable to perform the detection of unauthorized access on the information processing device 1 in real time.

There is a case in which the worker terminal 2 which is infected with malware performs similar operations to the worker terminal 2 which is operated by the normal user (for example, access to system resources). Therefore, there is a case in which the worker may be unable to perform the detection of unauthorized access using log analysis.

Therefore, in the present embodiment, the information processing device 1 creates (generates) work identification information which accompanies the work which accompanies the execution of each process based on the correspondence information in which events are associated with every process which is executed on the information processing device 1, and accumulates the work identification information in the storage section 1a. In a case in which a new work (hereinafter also referred to as the first work) is performed, the information processing device 1 determines that the first work is abnormal in a case in which the work identification information which is created from the first work is different from the work identification information that is stored in the storage section 1a.

In other words, the normal worker (the worker that is permitted to execute works on the information processing device 1) performs a work for executing the process of the information processing device 1 on the worker terminal 2 in advance, for example. The information processing device 1 creates the correspondence information for every process based on the events which are generated by the normal worker performing works. The information processing device 1 accumulates the work identification information which identifies the works which are performed by the normal worker in the storage section is based on the created correspondence information.

Subsequently, in a case in which the first work is performed on the information processing device 1, the work identification information (hereinafter also referred to as the new work identification information) which is created from the first work is compared with the work identification information which is accumulated in the storage section 1a in advance. In a case in which the work identification information of the same content as the new work identification information which is created from the first work is accumulated in the storage section 1a, the information processing device 1 determines that the person that performed the first work is a normal worker. Meanwhile, in a case in which the work identification information of the same content as the new work identification information which is created from the first work is not accumulated in the storage section 1a, the information processing device 1 determines that the person that performed the first work is not a normal worker.

Accordingly, it becomes possible for the information processing device 1 to perform detection of works which may be abnormal works (for example, unauthorized access to the information processing device 1) among the works which are performed on the information processing device 1. It becomes possible for the worker to perform a detailed investigation of the detected works.

Hardware Configuration of Management Device

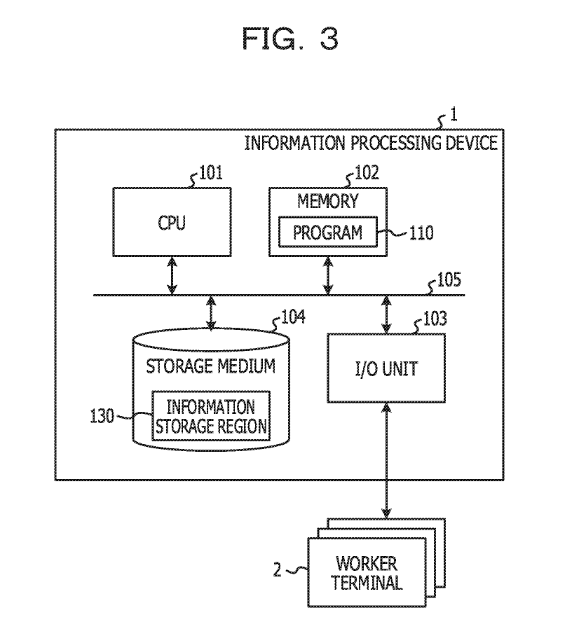

Next, description will be given of the configuration of the information processing system 10. FIG. 3 is an explanatory diagram of the hardware configuration of the information processing device 1.

The information processing device 1 includes a CPU 101 which is a processor, a memory 102, an external interface (an I/O unit) 103, and a storage medium 104. These elements are connected to each other via a bus 105.

The storage medium 104 stores a program 110 (hereinafter also referred to as the abnormality detection program 110) for performing a process (hereinafter also referred to as the abnormality detection process) which performs detection of an abnormal work in a program storage region (not illustrated) within the storage medium 104.

As illustrated in FIG. 3, when executing the program 110, the CPU 101 loads the program 110 into the memory 102 from the storage medium 104 and performs the abnormality detection process in cooperation with the program 110.

The storage medium 104 includes an information storage region 130 (hereinafter also referred to as the storage section 130) which stores information that is used when performing the abnormality detection process, for example. The external interface 103 performs communication with the worker terminal 2. Note that, the information storage region 130 corresponds to the storage section is described in FIG. 1, for example.

Software Configuration of Information Processing Device

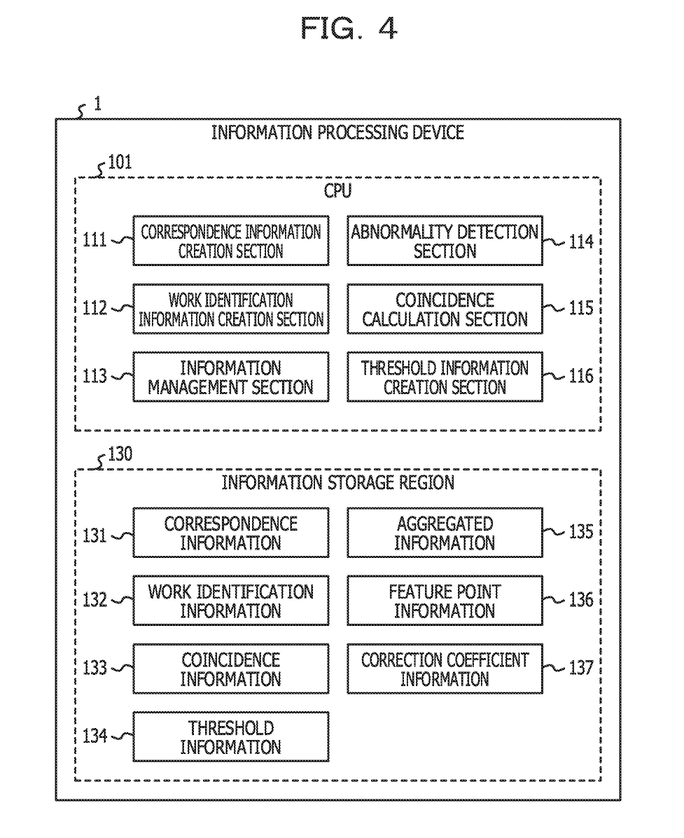

Next description will be given of the software configuration of the information processing device 1. FIG. 4 is a functional block diagram of the information processing device 1 of FIG. 3. By cooperating with the program 110, the CPU 101 operates as a correspondence information creation section 111 (hereinafter also referred to as the correspondence information generation section 111), a work identification information creation section 112 (hereinafter also referred to as the work identification information generation section 112), an information management section 113, an abnormality detection section 114 (hereinafter also referred to simply as the processing section 114), a coincidence calculation section 115, and a threshold information creation section 116. Correspondence information 131, work identification information 132, coincidence information 133, threshold information 134, aggregated information 135, feature point information 136, and correction coefficient information 137 are stored in the information storage region 130.

The correspondence information creation section 111 creates the correspondence information 131. The correspondence information 131 is information which is created by associating the events that are generated accompanying the execution of a plurality of processes which are executed on the information processing device 1 with every process. The correspondence information 131 is created from information (hereinafter also referred to as the access information) indicating that access to the system resources (for example, the application and the OS which operate on the worker terminal 2 and the information processing device which receive the input of information) of the information processing device 1 has occurred, for example.

A process or the like which is executed in a case in which there is input of a command to the OS which operates on the information processing device 1 instructing the OS to create a new file, for example, corresponds to a process that is executed on the information processing device 1.

The event which occurs accompanying the execution of a process is an event which occurs in order to bring about a state change in the business system, for example. Specifically, a system call for calling a function of the OS, receipt of input of the input device 2, notification which is generated between processes, or the like corresponds to an event. Description of a specific example of the correspondence information 131 will be given later.

The work identification information creation section 112 performs creation of the work identification information 132 which is information that identifies a work in which a process is executed. This work is a grouping of operations (operations performed by the worker via the input device 2) for causing the business system to execute a predetermined process. Specifically, the work identification information creation section 112 refers to the correspondence information 131 which is created by the correspondence information creation section 111, and creates the work identification information 132 from the events that are associated with the process corresponding to each work for every work in which processes are executed. Description of a specific example of the work identification information 132 will be given later.

The information management section 113 stores the work identification information 132 which is created by the work identification information creation section 112 in the information storage region 130. The information management section 113 stores the correspondence information 131 which is created by the correspondence information creation section 111 in the information storage region 130, for example.

The abnormality detection section 114 waits until the first work in which the process (hereinafter also referred to as the first process) that is executed on the information processing device 1 is executed. In a case in which the first work is performed, the abnormality detection section 114 determines whether or not the new work identification information which is created from the first work is different from the work identification information 132 relating to the first process among the work identification information 132 that is accumulated in the information storage region 130. As a result, in a case in which the new work identification information is different from the work identification information 132 that is accumulated in the information storage region 130, the abnormality detection section 114 determines that the first work is an abnormal work. In other words, in this case, the abnormality detection section 114 detects that there is a possibility that the first work is a work that is performed by an attacker. Note that, in a case in which the first work is performed, the abnormality detection section 114 may create new work identification information by causing the correspondence information creation section 111 and the work identification information creation section 112 to execute processes, for example.

The coincidence calculation section 115 calculates each item of the coincidence information 133 (hereinafter also referred to as the first value) between the information contained in the new work identification information which is created by the abnormality detection section 114 and the information contained in the work identification information 132 that is accumulated in the information storage region 130. In a case in which the coincidence information 133 which is calculated by the coincidence calculation section 115 is less than a predetermined threshold (hereinafter also referred to as the threshold information 134), the abnormality detection section 114 determines that the first work is abnormal. Description of a specific example of the coincidence information 133 will be given later. Note that, in this case, the information management section 113 stores the coincidence information 133 which is calculated by the coincidence calculation section 115 in the information storage region 130, for example.

The threshold information creation section 116 determines the threshold information 134. Specifically, the threshold information creation section 116 determines whether or not the timestamp (hereinafter also referred to as the first timestamp) at which the work identification information of the same content as the work identification information 132 that is accumulated in the information storage region 130 is previously created is a timestamp earlier than a predetermined timestamp (for example, one month earlier than the present timestamp), for example. In a case in which the first timestamp is a timestamp earlier than the predetermined timestamp, the threshold information creation section 116 determines a lower value than in a case in which the first timestamp is later than the predetermined timestamp as the threshold information 134. Description of a specific example of the threshold information 134 will be given later.

Note that, description of the aggregated information 135, the feature point information 136, and the correction coefficient information 137 will be given later.

Outline of First Embodiment

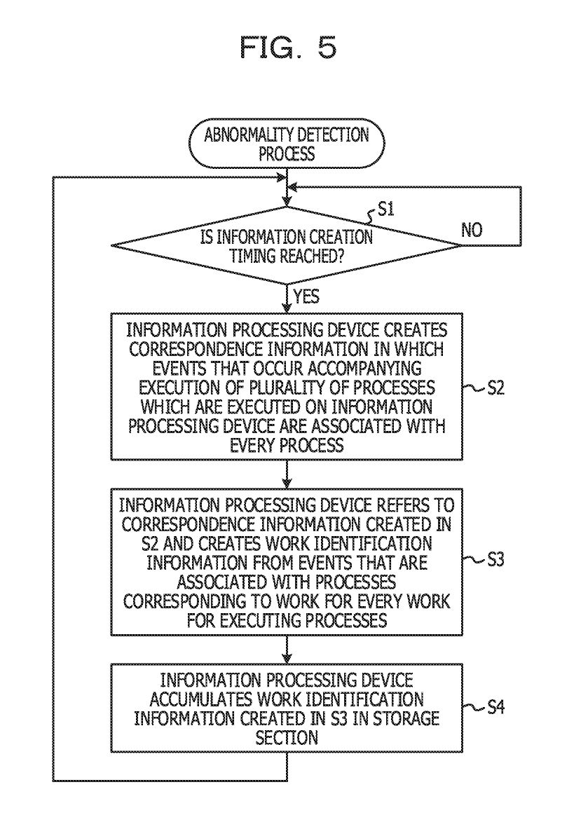

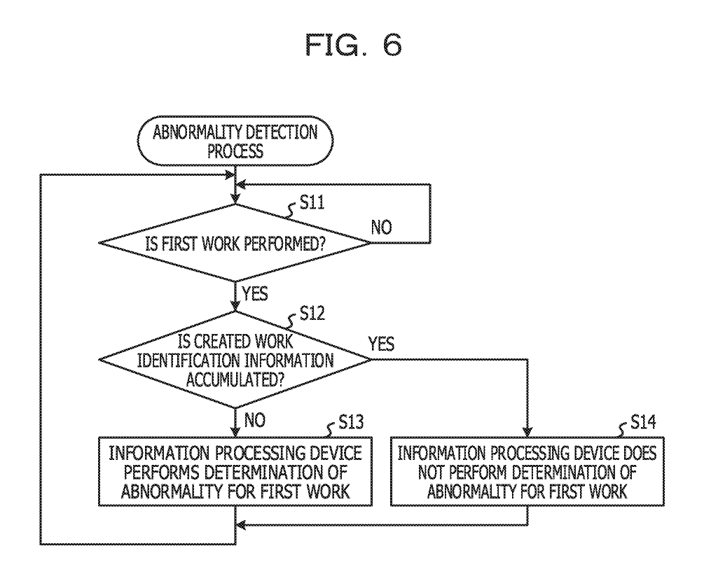

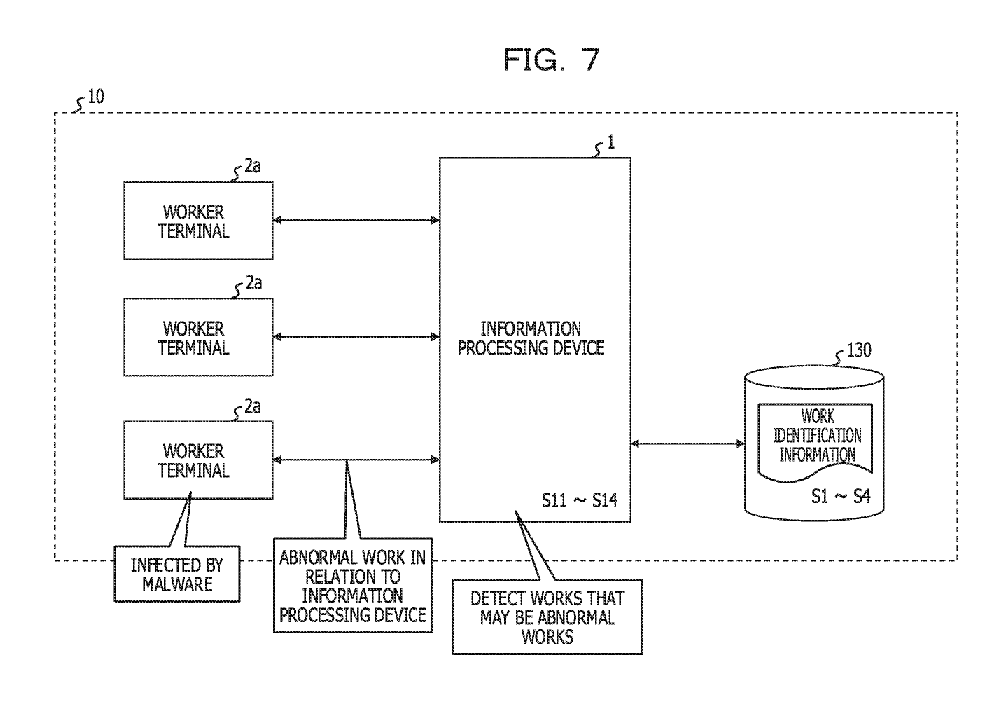

Next, description will be given of an outline of the first embodiment. FIGS. 5 and 6 are flowcharts describing an outline of an abnormality detection process in the first embodiment. FIG. 7 is a diagram describing an outline of the abnormality detection process in the first embodiment. Description will be given of the outline of the abnormality detection process of FIGS. 5 and 6 with reference to FIG. 7.

Process During Accumulation of Work Identification Information 132 in Information Storage Region 130

Initially, description will be given of the processes during the accumulation of the work identification information 132 in the information storage region 130. As illustrated in FIG. 5, the information processing device 1 waits until the information creation timing (NO in S1). The information creation timing is a timing earlier than when the detection of the abnormal work is started, for example. In other words, the information processing device 1 creates the work identification information 132 based on a work by a normal worker and stores the work identification information 132 in the information storage region 130 before starting the detection of an abnormal work described later.

In a case in which the information acquisition timing is reached (YES in S1), the information processing device 1 creates the correspondence information 131 in which the events that occur accompanying the execution of the process which is executed on the information processing device 1 are associated with every process (S2). Next, the information processing device 1 refers to the correspondence information 131 which is created in S2 and creates the work identification information 132 from the events that are associated with the processes corresponding to each work for every work for executing processes on the information processing device 1 (S3). Subsequently, as illustrated in FIG. 7, the information processing device 1 accumulates the created work identification information 132 in the information storage region 130 (S4).

In other words, the features of the work (the operation) which is performed on the worker terminal 2 are different depending on the person (including the worker and the attacker) that performs the work. Specifically, for example, when performing a work on the worker terminal 2, there is a person that frequently uses shortcut keys of the keyboard and a person that does not. Information relating to the work content and the work time which is performed on the worker terminal 2 is included in the event that is generated accompanying the execution of a process. Therefore, a normal worker performs a work for executing a process of the information processing device 1 on the worker terminal 2 in advance. The information processing device 1 creates the work identification information 132 and accumulates the work identification information 132 in the information storage region 130 in advance based on the events that occur accompanying the execution of the work of the normal worker.

Accordingly, in a case in which the first work is performed, it becomes possible for the information processing device 1 to determine that there is a possibility that the first work is performed by an attacker in a case in which work identification information of the same content as the new work identification information that is created from the first work is not accumulated in the information storage region 130. Therefore, in this case, it becomes possible for the information processing device 1 to perform a detailed investigation of the first work.

The information processing device 1 creates the work identification information 132 based on only the information for identifying each work, for example. Therefore, it becomes possible for the information processing device 1 to shorten the processing time when determining whether or not the person that performed the first work is a normal worker. Therefore, in a case in which the first work is performed, it becomes possible for the information processing device 1 to determine whether or not the person that performed the first work is a normal worker in real time, for example.

Process During Determination of whether or not to Determine First Work Abnormal

Next, description will be given of the process during the determination of whether or not to determine that the first work is abnormal. As illustrated in FIG. 6, the information processing device 1 waits until the first work is performed (NO in S11).

In a case in which the first work is performed (YES in S11), as illustrated in FIG. 7, the information processing device 1 determines whether or not the work identification information which is created from the first work is contained in the work identification information relating to the first process among the work identification information 132 that is stored in the information storage region 130 (S12). Specifically, in a case in which the first work is performed, for example, the information processing device 1 creates the new work identification information by performing the processes described in S2 and S3 of FIG. 5. The information processing device 1 performs the process of S12 by comparing the information contained in the work identification information 132 that is stored in the information storage region 130 with the information contained in the new work identification information.

Next, in a case in which work identification information of the same content as the new work identification information is not accumulated in the information storage region 130 (NO in S12), the information processing device 1 determines whether or not the first work is an abnormal work (S13). In other words, in this case, the information processing device 1 determines that the features of the first work are different from the features of the work which is performed in advance by a normal worker. Therefore, it becomes possible for the information processing device 1 to determine that the first work may be a work (an abnormal work) that is performed by a person (for example, an attacker) that is not a normal worker.

Meanwhile, in a case in which work identification information of the same content as the new work identification information is accumulated in the information storage region 130 (YES in S12), the information processing device 1 does not perform the determination of whether or not the first work is an abnormal work (S14). In other words, in this case, the information processing device 1 determines that the first work is a work which is performed by a normal worker. Description of a specific example of the process of S12 will be given later.

In this manner, according to the first embodiment, the information processing device 1 creates the correspondence information 131 in which the events that occur accompanying the execution of the plurality of processes which are executed on the information processing device 1 are associated with every process based on the access information in relation to the system resources of the information processing device 1. The information processing device 1 refers to the correspondence information 131, creates the work identification information 132 which identifies each work from the events that are associated with the processes corresponding to each work for every work in which processes are executed, and accumulates the work identification information 132 in the information storage region 130.

In a case in which the first work which executes the first process that is executed on the information processing device 1 is performed, the information processing device 1 determines that the first work is abnormal in a case in which the work identification information that is created from the first work is different from the work identification information 132 relating to the accumulated first process.

Accordingly, it becomes possible for the information processing device 1 to perform detection of works which may be abnormal works among the first works which are performed on the information processing device 1. It becomes possible for the worker to perform a detailed investigation of the detected works, for example.

Details of First Embodiment

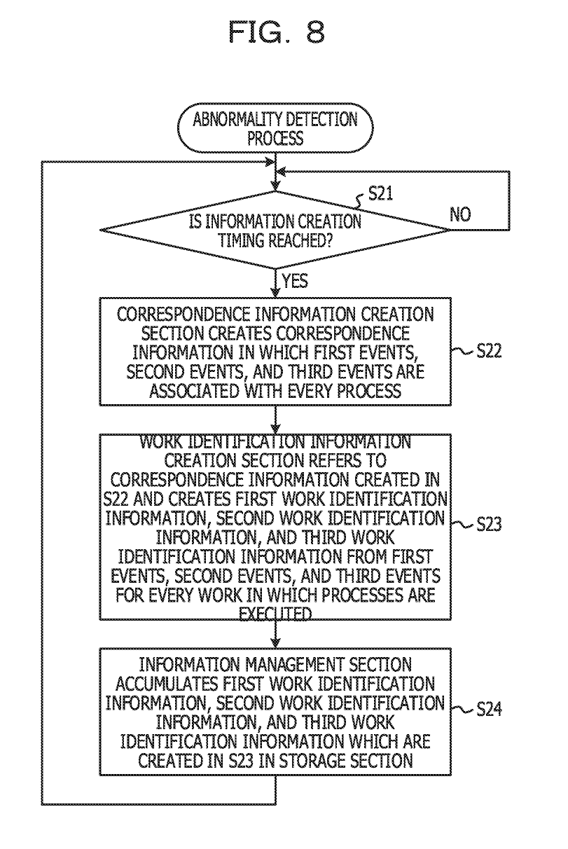

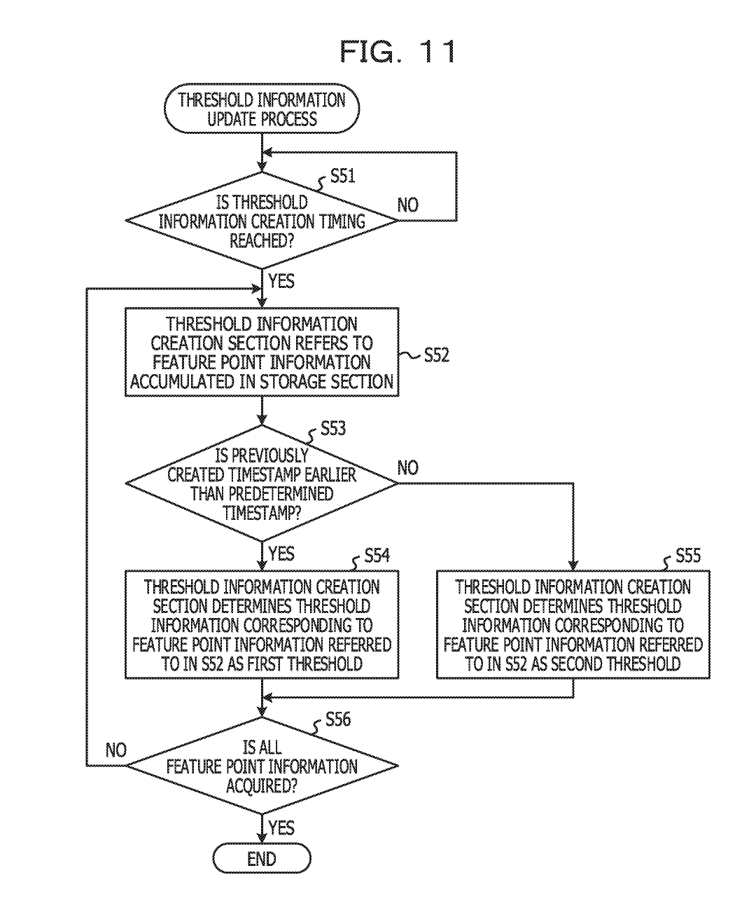

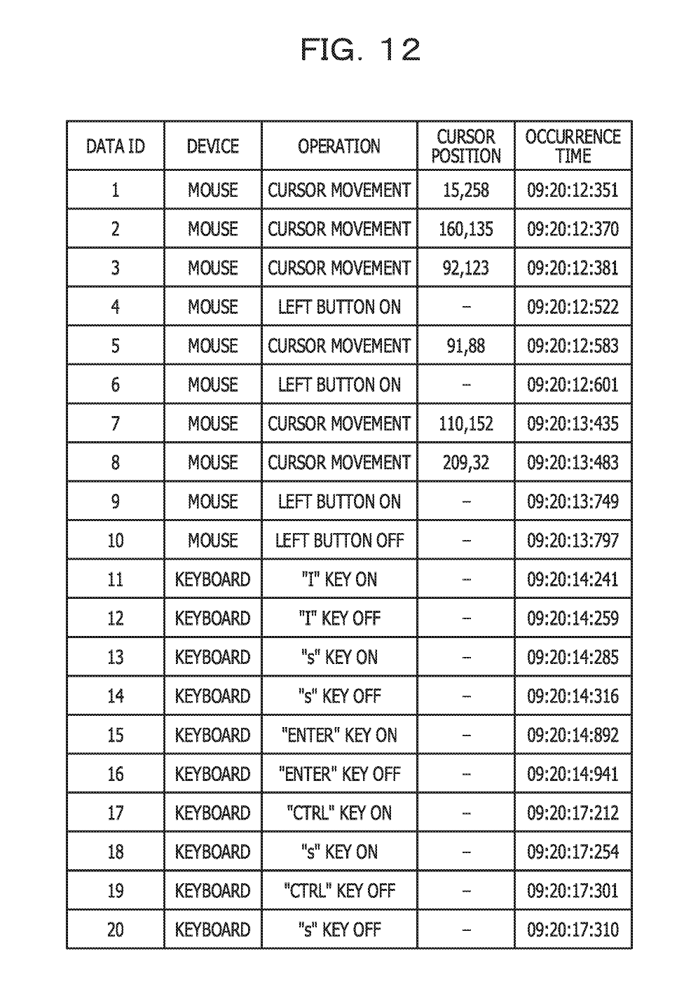

Next, detailed description will be given of the first embodiment. FIGS. 8 to 11 are flowcharts describing the details of the abnormality detection process in the first embodiment. FIGS. 12 to 30 are diagrams describing the details of the abnormality detection process in the first embodiment. Description will be given of the abnormality detection process of FIGS. 8 to 11 with reference to FIGS. 12 to 30.

Process During Accumulation of Work Identification Information 132 in Information Storage Region 130

Initially, description will be given of the processes during the accumulation of the work identification information 132 in the information storage region 130. As illustrated in FIG. 8, the correspondence information creation section 111 of the information processing device 1 waits until the information creation timing (NO in S21). In a case in which the information acquisition timing is reached (YES in S21), the correspondence information creation section 111 creates the correspondence information 131 in which the first events, the second events, and the third events are each associated with every process (S22). Hereinafter, description will be given of the first events, the second events, and the third events. Note that, hereinafter, description is performed with the assumption that the first events, the second events, and the third events are already acquired by the correspondence information creation section 111 or the like, and are accumulated in the information storage region 130.

The first event is an event which occurs accompanying the execution of the processes that are executed according to the input of the information to the worker terminal 2, for example. Specifically, the first event is an event which occurs when the worker inputs information using a keyboard or a mouse of the worker terminal 2 in order to access the information storage region 130, for example.

The second event is an event which occurs accompanying the execution of the processes which are executed according to the occurrence of access to an application that runs on the information processing device 1, for example. Specifically, the second event is an event which occurs when an application transmits a command for requesting the execution of a process to the OS corresponding to the worker inputting information via the worker terminal 2, for example.

The third event is an event which occurs accompanying the execution of the processes which are executed according to the occurrence of access to the OS that runs on the information processing device 1, for example. Specifically, the third event is an event which occurs when the OS executes a process based on a command which is received from an application, for example.

Specific Examples of First Events, Second Events, And Third Events

Next, description will be given of specific examples of the first events, the second events, and the third events.

FIG. 12 is an explanatory diagram of specific examples of the information contained in the first events. The first events illustrated in FIG. 12 include, as headings, “data ID” for identifying each item of information contained in the first event, and “device” for identifying the device (the device of the worker terminal 2) to which information is input. More headings included in the first events illustrated in FIG. 12 are “operation” for identifying the operation performed by the worker via the device, and “cursor position” which indicates the cursor position of the mouse on a display device (not illustrated) of the worker terminal 2. Still another heading of the first events illustrated in FIG. 12 is “occurrence time” indicating the time at which the operation corresponding to each item of information contained in the first events is performed.

Specifically, in the first events illustrated in FIG. 12, in the information with a “data ID” of “1”, “device” is “mouse”, “operation” is “cursor movement”, “cursor position” is “15, 258”, and “occurrence time” is “09:20:12:351”. In the first events illustrated in FIG. 12, in the information with a “data ID” of “2”, “device” is “mouse”, “operation” is “cursor movement”, “cursor position” is “160, 135”, and “occurrence time” is “09:20:12:370”. Note that, the first event in a case in which “device” is “mouse” may be when the worker starts and when the worker ends input using the mouse. In other words, in a case in which the worker moves the cursor on the display device using a mouse, the information processing device 1 may output a first event when the movement of the cursor is started and when the movement of the cursor is ended. In a case in which the worker presses the left button of the mouse, the information processing device 1 may output a first event when the left button of the mouse is pressed and when the pressing of the left button of the mouse ends.

In the first events illustrated in FIG. 12, in the information with a “data ID” of “11”, “device” is “keyboard”, “operation” is “I′key ON”, “cursor position” is blank, and “occurrence time” is “09:20:14:241”. The first event in a case in which “device” is “keyboard” may be output every single time the key is pressed. Description of the other information of FIG. 12 will be omitted.

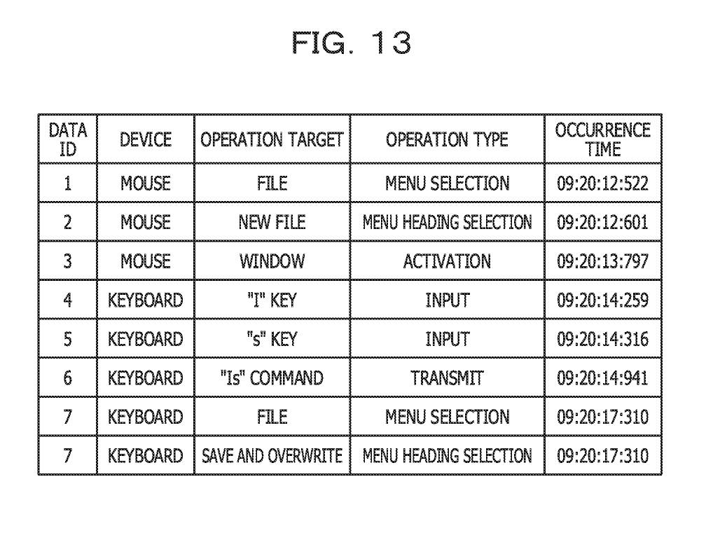

Next, description will be given of specific examples of the second events. FIG. 13 is an explanatory diagram of specific examples of the information contained in the second events.

The second events illustrated in FIG. 13 include, as headings, “data ID” for identifying each item of information contained in the second events, and “device” for identifying the device (the device of the worker terminal 2) to which information is input. More headings of the second events illustrated in FIG. 13 are “operation target” for identifying the operation target, “operation type” for identifying the type of the operation, and “occurrence time” indicating the time at which the each item of information contained in the second events is output.

Specifically, in the second events illustrated in FIG. 13, in the information with a “data ID” of “1”, “device” is “mouse”, “operation target” is “file”, “operation type” is “menu selection”, and “occurrence time” is “09:20:12:522”. In other words, the information with a “data ID” of “1” in the second events illustrated in FIG. 13 is information corresponding to the worker selecting a menu that is identified by “file” among the menus which are displayed on the display device of the worker terminal 2, for example. Description of the other information of FIG. 13 will be omitted.

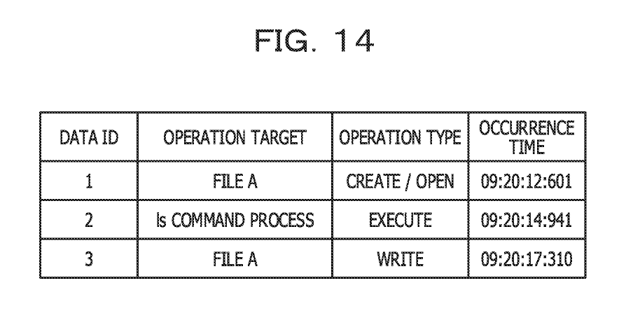

Next, description will be given of specific examples of the third events. FIG. 14 is an explanatory diagram of specific examples of the information contained in the third events.

The third events illustrated in FIG. 14 include, as headings, “data ID” for identifying each item of information contained in the third events, “operation target” for identifying the operation target, “operation type” for identifying the type of the operation, and “occurrence time” indicating the time at which the each item of information contained in the third events is output.

Specifically, in the third events illustrated in FIG. 14, in the information with a “data ID” of “1”, “operation target” is “file A”, “operation type” is “create/open (create and open)”, and “occurrence time” is “09:20:12:601”. In other words, in the third events illustrated in FIG. 14, the information with a “data ID” of “1” indicates that a process for creating the file A and a process for opening the file A are executed according to the input of information by the worker. Description of the other information of FIG. 14 will be omitted.

Specific Examples of Correspondence Information 131

Next, description will be given of specific examples of cases in which the correspondence information creation section 111 creates the correspondence information 131. The correspondence information creation section 111 creates the correspondence information 131 corresponding to each of the first events, the second events, and the third events by classifying each item of information contained in each of the first events, the second events, and the third events for each process, for example. Hereinafter, the correspondence information 131 will be described as containing a first correspondence information 131a corresponding to the first events, a second correspondence information 131b corresponding to the second events, and a third correspondence information 131c corresponding to the third events.

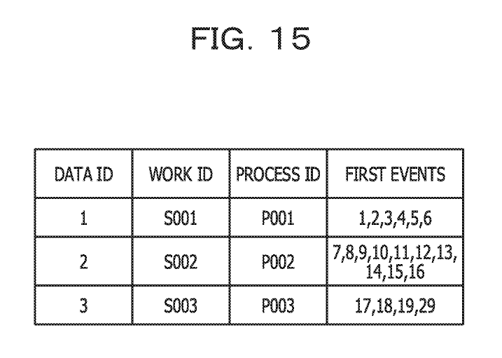

First, description will be given of the specific examples of the first correspondence information 131a. FIG. 15 is an explanatory diagram of specific examples of the first correspondence information 131a. The first correspondence information 131a illustrated in FIG. 15 includes, as headings, “data ID” which identifies each item of information contained in the first correspondence information 131a, “work ID” which identifies each work, and “process ID” which identifies each process. Another heading included in the first correspondence information 131a illustrated in FIG. 15 is “first events” which identifies the information contained in the first events. The information which is set in “first events” in the first correspondence information 131a illustrated in FIG. 15 corresponds to the information that is set in “data ID” in the first events described in FIG. 12.

Specifically, in the first correspondence information 131a illustrated in FIG. 15, in the information in which “data ID” is “1”, “work ID” is set to “S001”, and “process ID” is set to “P001”. In the first correspondence information 131a illustrated in FIG. 15, in the information in which “data ID” is“1”, “first events” is set to “1, 2, 3, 4, 5, 6”. Description of the other information of FIG. 15 will be omitted.

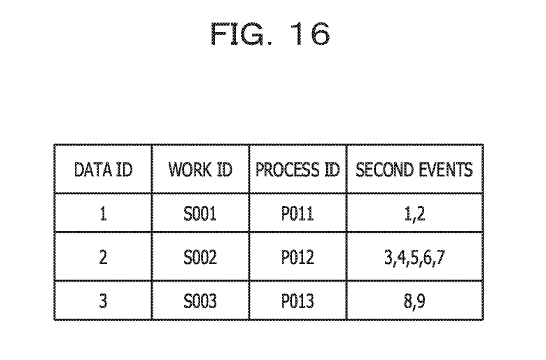

Next, description will be given of the specific examples of the second correspondence information 131b. FIG. 16 is an explanatory diagram of specific examples of the second correspondence information 131b. The second correspondence information 131b illustrated in FIG. 16 includes, as headings, “data ID” which identifies each item of information contained in the second correspondence information 131b, “work ID” which identifies each work, and “process ID” which identifies each process. Another heading included in the second correspondence information 131b illustrated in FIG. 16 is “second events” which identifies the information contained in the second events. The information which is set in “second events” in the second correspondence information 131b illustrated in FIG. 16 corresponds to the information that is set in “data ID” in the second events described in FIG. 13.

Specifically, in the second correspondence information 131b illustrated in FIG. 16, in the information in which “data ID” is “1”, “work ID” is set to “S001”, and “process ID” is set to “P011”. In the second correspondence information 131b illustrated in FIG. 16, in the information in which “data ID” is “1”, “second events” is set to “1, 2”. Description of the other information of FIG. 16 will be omitted.

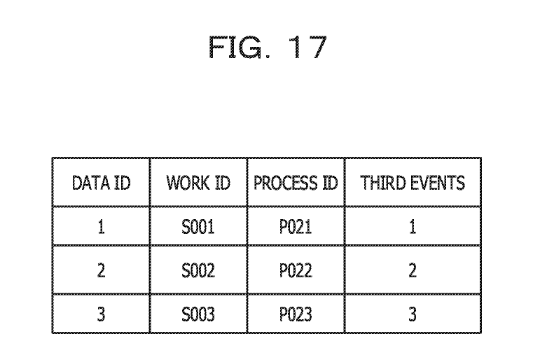

Next, description will be given of the specific examples of the third correspondence information 131c. FIG. 17 is an explanatory diagram of specific examples of the third correspondence information 131c. The third correspondence information 131c illustrated in FIG. 17 includes, as headings, “data ID” which identifies each item of information contained in the third correspondence information 131c, “work ID” which identifies each work, and “process ID” which identifies each process. Another heading included in the third correspondence information 131c illustrated in FIG. 17 is “third events” which identifies the information contained in the third events. The information which is set in “third events” in the third correspondence information 131c illustrated in FIG. 17 corresponds to the information that is set in “data ID” in the third events described in FIG. 14.

Specifically, in the third correspondence information 131c illustrated in FIG. 17, in the information in which “data ID” is “1”, “work ID” is set to “S001”, and “process ID” is set to “P021”. In the third correspondence information 131c illustrated in FIG. 17, in the information in which “data ID” is “1”, “third events” is set to “1”. Description of the other information of FIG. 17 will be omitted.

In other words, the first correspondence information 131a, the second correspondence information 131b, and the third correspondence information 131c illustrated in FIGS. 15 to 17 contain information indicating that the processes in which “process ID” is “P001”, “P011”, and “P021” correspond to works in which “work ID” is “S001”. Therefore, it becomes possible for the work identification information creation section 112 to associate the events with the processes which are the sources of the occurrence of each event and the work in which each process is executed by referring to the correspondence information 131. Therefore, as described later, it becomes possible for the work identification information creation section 112 to create the work identification information 132 for every work by referring to the correspondence information 131.

Returning to FIG. 8, the work identification information creation section 112 refers to the correspondence information 131 which is created by the correspondence information creation section 111. The work identification information creation section 112 creates each of a first work identification information 132a, a second work identification information 132b, and a third work identification information 132c which are contained in the work identification information 132 from the first events, the second events, and the third events for every work in which processes are executed (S23). Hereinafter, description will be given of specific examples of the first work identification information 132a, the second work identification information 132b, and the third work identification information 132c.

Specific Examples of First Work Identification Information 132a

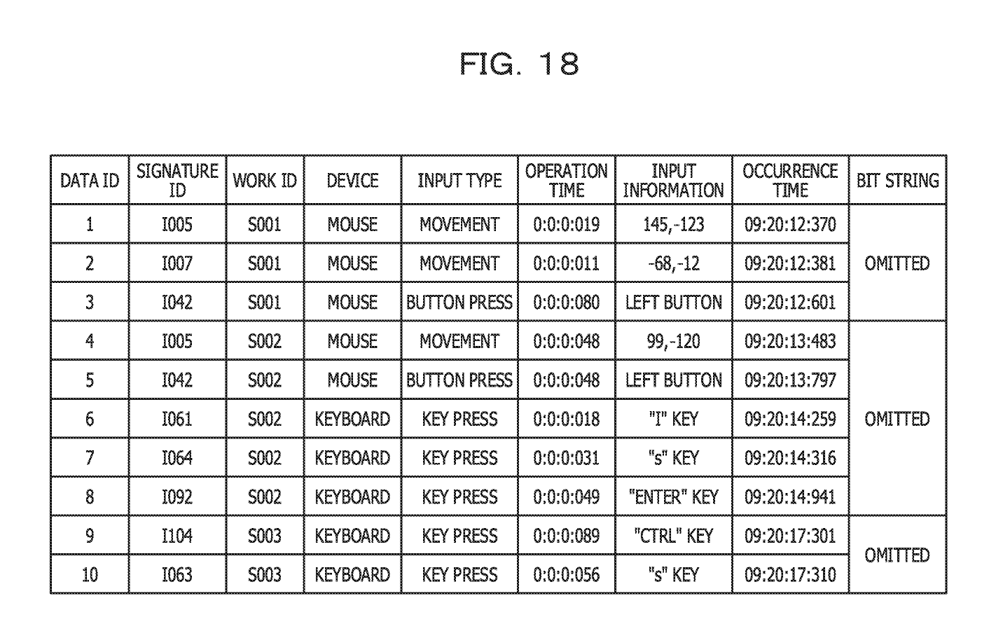

FIG. 18 is an explanatory diagram of specific examples of the first work identification information 132a. The first work identification information 132a illustrated in FIG. 18 is information which is created based on the information contained in the first events which are described in FIG. 12. The first work identification information 132a illustrated in FIG. 18 includes, as headings, “data ID” which identifies each item of information contained in the first work identification information 132a, “signature ID” which identifies a first aggregated information 135a (described later), and “work ID” which identifies each work. More headings included in the first work identification information 132a illustrated in FIG. 18 are “device” which identifies the device with which the input of information is performed, and “input type” which identifies the type of the information that is input. Still more headings included in the first work identification information 132a illustrated in FIG. 18 are “operation time” which is the time taken for the input of information, “input information” which is the information contained in the input information, and “occurrence time” indicating the time at which the each item of information is output. The final heading included in the first work identification information 132a illustrated in FIG. 18 is “bit string” which is a bit string corresponding to the information which is set in “signature ID”. Note that, in “bit string”, a bit string is set for every item of information that is set in “work ID”.

Specifically, in the first work identification information 132a illustrated in FIG. 18, in the information in which “data ID” is “1”, “signature ID” is set to “I005”, and “work ID” is set to “S001”. The information that is set in “work ID” is determined by referring to the first correspondence information 131a described in FIG. 15, for example. The determination method of the information that is set in “signature ID” will be described later.

In the first work identification information 132a illustrated in FIG. 18, in the information in which “data ID” is “1”, “device” is set to “mouse”, and “input type” is set to “movement”. The information that is set in “device” is determined corresponding to the information that is set in “device” in the first events described in FIG. 12, for example. The information that is set in “input type” is determined corresponding to the information that is set in “operation” in the first events described in FIG. 12, for example.

In the first work identification information 132a illustrated in FIG. 18, in the information in which “data ID” is “1”, “operation time” is set to “0:0:0:019”, and “input information” is set to “145, −123”. The information that is set in “device” in FIG. 18 is determined based on the information that is set in “occurrence time” in the first events described in FIG. 12. In other words, the information which is set in “operation time” of the information in which “data ID” is “1” is the difference between the information set in “occurrence time” of the information in which “data ID” is “1” in the first events illustrated in FIG. 12 and the information which is set in “occurrence time” of the information in which “data ID” is “2”. The information which is set in “input information” in FIG. 18 is determined based on the information that is set in “cursor position” in the first events described in FIG. 12. In other words, the information which is set in “input information” of the information in which “data ID” is “1” is the difference between the information set in “cursor position” of the information in which “data ID” is “1” in the first events illustrated in FIG. 12 and the information which is set in “cursor position” of the information in which “data ID” is “2”.

Note that, in a case in which information is not set in “cursor position” of the first event information illustrated in FIG. 12, other information may be set in “input information”. Specifically, “left button” which is the information contained in “operation” corresponding to the information in which “data ID” is “4” and “5” in FIG. 12 is set in the information in which “data ID” is “3” in the first work identification information 132a illustrated in FIG. 18. Additionally, “'I′ key” which is the information contained in “operation” corresponding to the information in which “data ID” is “11” and “12” in FIG. 12 is set in the information in which “data ID” is “6” in the first work identification information 132a illustrated in FIG. 18.

In the first work identification information 132a illustrated in FIG. 18, “09:20:12:370” which is the information which is set in “occurrence time” of the information in which “data ID” is “2” in the first events illustrated in FIG. 12 is set in the information in which “data ID” is “1”. In other words, of the information that is set in “occurrence time” of the first events illustrated in FIG. 12, the information corresponding to each item of information contained in the first work identification information 132a is set in “occurrence time” of the first work identification information 132a. Note that, description of the bit strings which are set in “bit string” in the first work identification information 132a illustrated in FIG. 18 will be given later.

In this manner, the work identification information creation section 112 extracts the information for identifying the features of the works which a worker performs on the worker terminal 2 from the information contained in the first events, the second events, and the third events, and creates the work identification information 132. As described later, the abnormality detection section 114 and the coincidence calculation section 115 determine whether or not there is a possibility that the first work is an abnormal work using the created work identification information 132 instead of the log that is output from the business system, or the like. Accordingly, as described later, it becomes possible for the abnormality detection section 114 and the coincidence calculation section 115 to swiftly perform the detection of a work that has a likelihood of being an abnormal work.

Specific Example of First Aggregated Information 135a

Next, description will be given of specific examples of the first aggregated information 135a. The first aggregated information 135a is information for determining the information to be set in “signature ID” of the first work identification information 132a described in FIG. 18.

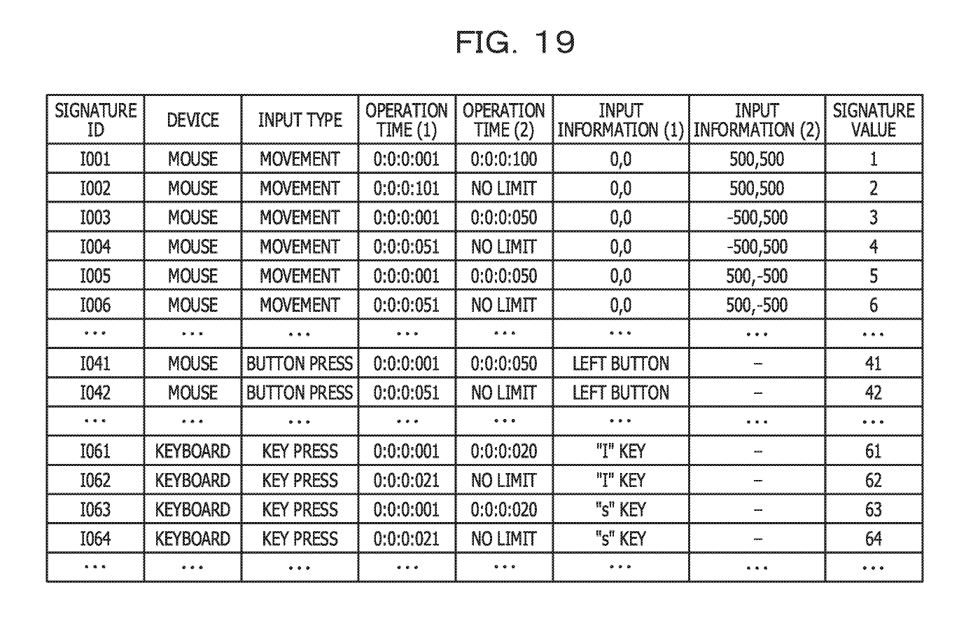

FIG. 19 is an explanatory diagram of a specific example of the first aggregated information 135a. The first aggregated information 135a illustrated in FIG. 19 includes, as headings, “signature ID” which identifies each item of information contained in the first aggregated information 135a, and “device” which identifies the device with which the input of information is performed. More headings included in the first aggregated information 135a illustrated in FIG. 19 are “input type” which identifies the type of the information which is input, and “operation time (1)” and “operation time (2)” indicating the time taken for the input of information. Still more headings included in the first aggregated information 135a illustrated in FIG. 19 are “input information (1)” and “input information (2)” indicating the information contained in the input information, and a “signature value” which is a value corresponding to the information that is set in “signature ID”. Values which uniquely specify each item of information contained in the first aggregated information 135a are set in the heading “signature value”.

Specifically, in the first aggregated information 135a illustrated in FIG. 19, in the information in which “signature ID” is “I001”, “device” is set to “mouse”, and “input type” is set to “movement”. In the first aggregated information 135a illustrated in FIG. 19, in the information in which “signature ID” is “I001”, “operation time (1)” is set to “0:0:0:001”, and “operation time (2)” is set to “0:0:0:100”. In the first aggregated information 135a illustrated in FIG. 19, in the information in which “signature ID” is “I001”, “input information (1)” is set to “0, 0”, “input information (2)” is set to “500, 500”, and “signature value” is set to “1”. Hereinafter, description will be given of a specific example of a case in which the information that is set in “signature ID” in the first work identification information 132a is determined.

For example, in a case in which, of the first work identification information 132a illustrated in FIG. 18, the information to be set in “device”, “input type”, “operation time”, and “input information” is determined, the work identification information creation section 112 refers to the first aggregated information 135a illustrated in FIG. 19. The work identification information creation section 112 specifies information containing information that is the same as the information to be set in “device”, “input type”, “operation time”, and “input information” of the first work identification information 132a illustrated in FIG. 18, of the first aggregated information 135a.

Specifically, in the first work identification information 132a illustrated in FIG. 18, in the information in which “data ID” is “1”, “device” is set to “mouse”, and “input type” is set to “movement”. In the first work identification information 132a illustrated in FIG. 18, in the information in which “data ID” is “1”, “operation time” is set to “0:0:0:019”, and “input information” is set to “145, −123”.

In this case, the work identification information creation section 112 specifies the information from the first aggregated information 135a illustrated in FIG. 19 in which the information that is set in “device” is “mouse” and the information that is set in “input type” is “movement”. The work identification information creation section 112 specified information in which “0:0:0:19” is included between the items of information which are set in “operation time (1)” and “operation time (2)”, and “145, −123” is contained in the information that is set in “input information (1)” and “input information (2)”.

As a result, the work identification information creation section 112 specifies the information from the first aggregated information 135a illustrated in FIG. 19 in which “signature ID” is “I005”. Therefore, in this case, the work identification information creation section 112 sets “signature ID” of the information in which “data ID” of the first work identification information 132a is “1” to “I005”.

Specific Examples of Determining Information set in “Bit String”

Next, description will be given of specific examples of determining the information to be set in “bit string” contained in the first work identification information 132a illustrated in FIG. 18.

By referring to the first aggregated information 135a illustrated in FIG. 19, for example, the work identification information creation section 112 acquires the values which are set in “signature value” which correspond to the information that is set in “signature ID” of the first work identification information 132a illustrated in FIG. 18. The work identification information creation section 112 converts the acquired values into a bit string and sets “bit string” of the first work identification information 132a illustrated in FIG. 18.

Accordingly, as described later, the abnormality detection section 114 and the coincidence calculation section 115 may determine whether or not to determine that the first work is abnormal by only performing a comparison of the bit strings that are set in “bit string” of the first work identification information 132a or the like. In other words, in this case, since the abnormality detection section 114 and the coincidence calculation section 115 may not have to refer to the other information contained in the first work identification information 132a or the like, it becomes possible to reduce the processing load expended when determining whether or not to determine that the first work is abnormal. Therefore, it becomes possible for the worker to determine whether or not to determine that the first work is abnormal in real time, for example. Hereinafter, description will be given of specific examples of cases in which the information to be set in “bit string” contained in the first work identification information 132a is determined.

For example, as illustrated in FIG. 18, the work identification information creation section 112 refers to the first aggregated information 135a in a case in which the information that is set in “signature ID” in the first work identification information 132a is determined to be “I005”. With regard to the first aggregated information 135a, the work identification information creation section 112 acquires “5” which is the information that is set in “signature value” of the information in which “signature ID” is “I005”.

Next, the work identification information creation section 112 associates the information which is acquired by referring to the first aggregated information 135a with the information which is set in “occurrence time” of the first work identification information 132a.

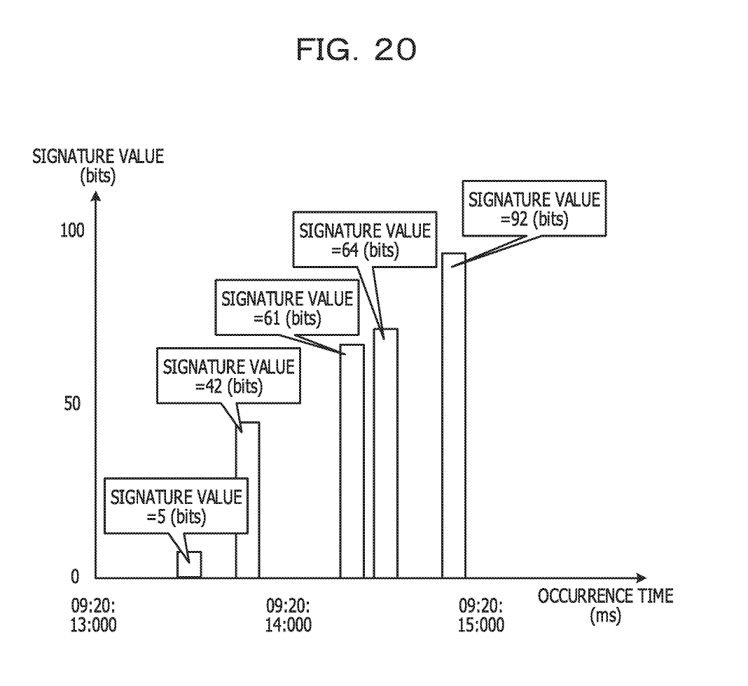

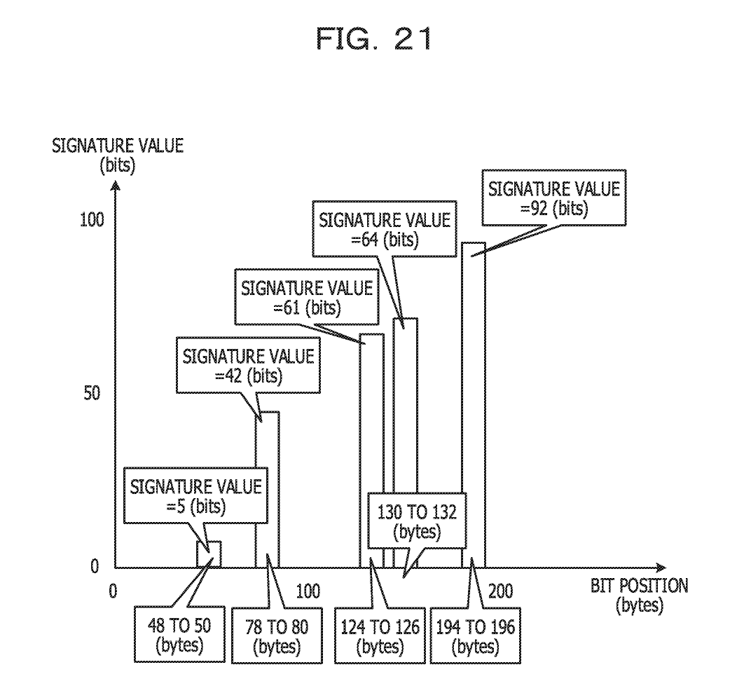

FIGS. 20 and 21 are graphs determining the bit strings that are set in “bit string” of the first work identification information 132a. FIG. 20 is a graph of a case in which the information which is set to “occurrence time” of the first work identification information 132a is set to the horizontal axis, and the information which is set to “signature value” which is acquired by referring to the first aggregated information 135a is set to the vertical axis. Hereinafter, description will be given of the information in which “work ID” is “S002” in the first work identification information 132a illustrated in FIG. 18.

Hereinafter, the minimum unit of the horizontal axis of the graph of FIG. 20 will be 20 (ms). In other words, for example, in the graph of FIG. 20, the information in which “occurrence time” is “09:20:17:310” will be set to a position on the horizontal axis indicating “from 09:20:17:300 to 09:20:17:320”.

Specifically, “occurrence time” of the information in which “data ID” is “4” in the first work identification information 132a illustrated in FIG. 18 is “09:20:13:483”. The “signature ID” of the information in which “data ID” is “4” in the first work identification information 132a is “I005”, and “signature value” of the information in which the “signature ID” is “I005” in the first aggregated information 135a is “5”.

Therefore, in this case, as illustrated in FIG. 20, the work identification information creation section 112 sets the specifiable information to a position in which the horizontal axis is “09:20:13:483” and the vertical axis is “5 (bits)”.

Similarly, for example, as illustrated in FIG. 20, the work identification information creation section 112 sets the specifiable information to a position in which the horizontal axis is “09:20:13:797” and the vertical axis is “42 (bits)” (the information in which “data ID” is “5” in FIG. 18). Description of the other information of FIG. 20 will be omitted.

Next, the work identification information creation section 112 replaces the horizontal axis in FIG. 20 with information indicating bit positions. FIG. 21 is a graph of a case in which the horizontal axis of the graph illustrated in FIG. 20 is replaced with the information indicating bit positions. Note that, hereinafter, description will be performed with the assumption that 20 (ms) in the horizontal axis of the graph illustrated in FIG. 20 corresponds to 2(bytes) in the horizontal axis of the graph illustrated in FIG. 21.

In this case, “09:20:12:483”, which is “occurrence time” of the information in which “data ID” is “4” in the first work identification information 132a, is included between “09:20:12:480” and “09:20:12:500”. The value “09:20:12:480” on the horizontal axis of the graph of FIG. 20 corresponds to “48 (bytes)” on the horizontal axis of the graph of FIGS. 21, and “09:20:12:500” on the horizontal axis of the graph of FIG. 20 corresponds to “50 (bytes)” on the horizontal axis of the graph of FIG. 21. Therefore, the work identification information creation section 112 determines that “5” which is the “signature value” of the information in which “signature ID” is “I005” in the first aggregated information 135a corresponds to “48 (bytes)” to “50 (bytes)” in the bit string. Description of the other information of FIG. 21 will be omitted.

The work identification information creation section 112 creates the information to be set in “bit string” of the first work identification information 132a illustrated in FIG. 18 based on the information contained in the graph illustrated in FIG. 21.

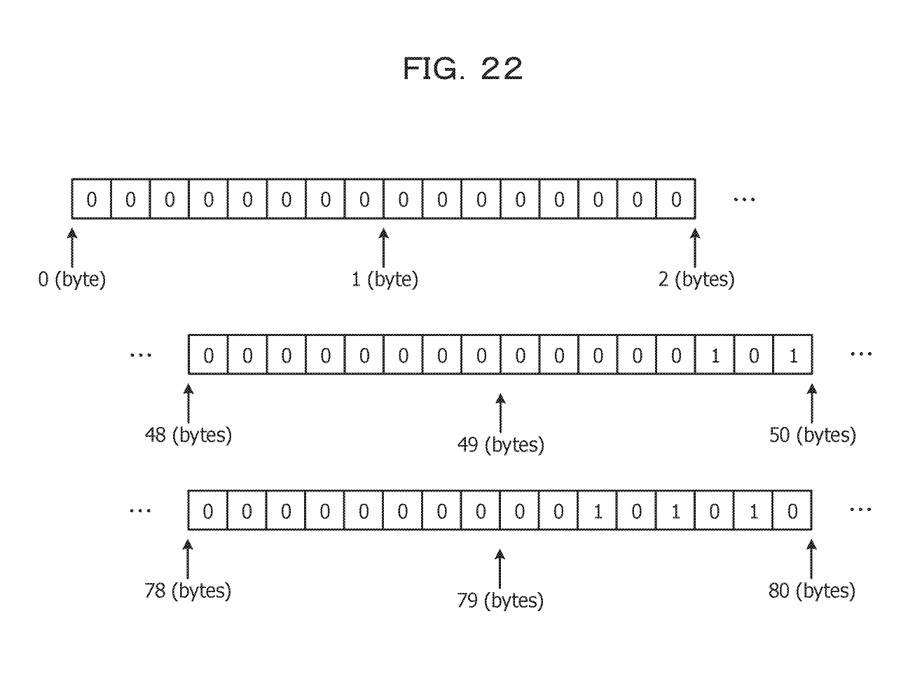

FIG. 22 is an explanatory diagram of specific examples of the information that is set in “bit string” of the first work identification information 132a. The work identification information creation section 112 prepares the bit string having the regions corresponding to the horizontal axis of the graph described in FIG. 21, for example. Specifically, in the example illustrated in FIG. 21, the work identification information creation section 112 prepares the bit string having a region of 200 (bytes), for example.

The work identification information creation section 112 sets “0000000000000101”, which is “5” in binary notation, at bit positions in the bit string illustrated in FIG. 22 from 48 (bytes) to 50 (bytes) (the information in which “data ID” is “4” in FIG. 18). The work identification information creation section 112 sets “0000000000101010”, which is “42” in binary notation, at bit positions in the bit string illustrated in FIG. 22 from 78 (bytes) to 80 (bytes) (the information in which “data ID” is “5” in FIG. 18). Description of the cases in which the other information contained in FIG. 21 is set in the bit string of FIG. 22 will be omitted.

Subsequently, the work identification information creation section 112 sets the created bit string (the bit string illustrated in FIG. 22) to “bit string” of the first work identification information 132a.

In other words, the work identification information creation section 112 includes the bit string obtained by converting the information contained in the first work identification information 132a in the first work identification information 132a. Accordingly, as described later, it becomes possible for the abnormality detection section 114 and the coincidence calculation section 115 to perform the comparison between the new work identification information which is created from a first work and the work identification information 132 which is stored in the information storage region 130 using only a comparison of the information which is set in “bit string”. Therefore, as described later, it becomes possible for the abnormality detection section 114 and the coincidence calculation section 115 to swiftly determine whether or not to determine that the first work is abnormal. Therefore, it becomes possible for a worker to determine whether or not a work which is performed on the information processing device 1 is performed by an attacker in real time, for example.

Specific Examples of Second Work Identification Information 132b

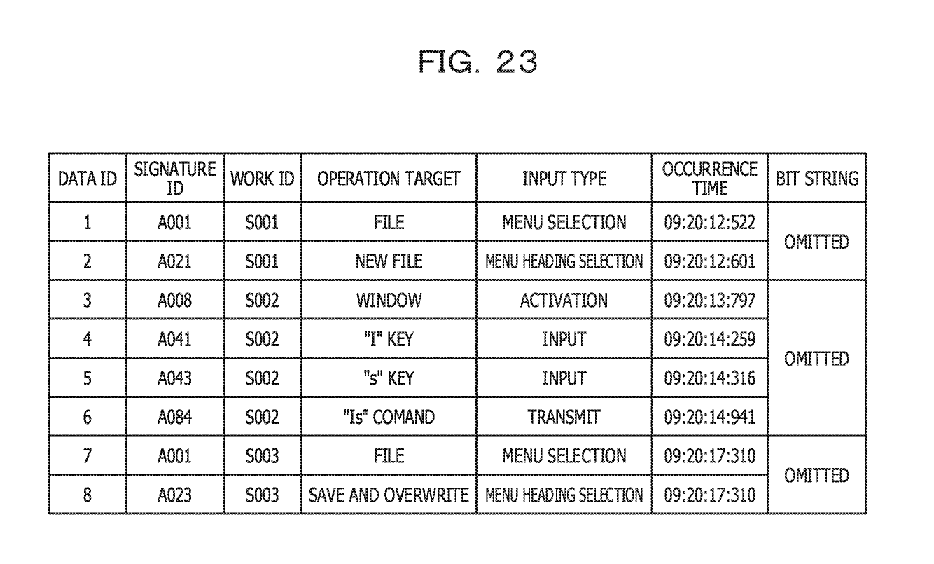

Next, description will be given of specific examples of the second work identification information 132b. FIG. 23 is an explanatory diagram of specific examples of the second work identification information 132b. The second work identification information 132b illustrated in FIG. 23 is information which is created based on the information contained in the second events which are described in FIG. 13.

The second work identification information 132b illustrated in FIG. 23 includes, as headings, “data ID” which identifies each item of information contained in the second work identification information 132b, “signature ID” which identifies a second aggregated information 135b (described later), and “work ID” which identifies each work. More headings included in the second work identification information 132b illustrated in FIG. 23 are “operation target” which identifies the operation target corresponding to the input information, and “input type” which identifies the type of the input information. Still more headings included in the second work identification information 132b illustrated in FIG. 23 are “occurrence time” which indicates the time at which each item of information is output, and “bit string” which is a bit string corresponding to the information which is set in “signature ID”. Note that, in “bit string”, a bit string is set for every item of information that is set in “work ID”.

Specifically, in the second work identification information 132b illustrated in FIG. 23, in the information in which “data ID” is “1”, “signature ID” is set to “A001”, and “work ID” is set to “S001”. In the second work identification information 132b illustrated in FIG. 23, in the information in which “data ID” is “1”, “operation target” is set to “file”, and “input type” is set to “menu selection”.

In the second work identification information 132b illustrated in FIG. 23, in the information in which “data ID” is “1”, “occurrence time” is set to “09:20:12:522”. Note that, description of the information that is set in “bit string” will be given later.

Specific Examples of Second Aggregated Information 135b

Next, description will be given of specific examples of the second aggregated information 135b. The second aggregated information 135b is information for determining the information to be set in “signature ID” of the second work identification information 132b described in FIG. 23.

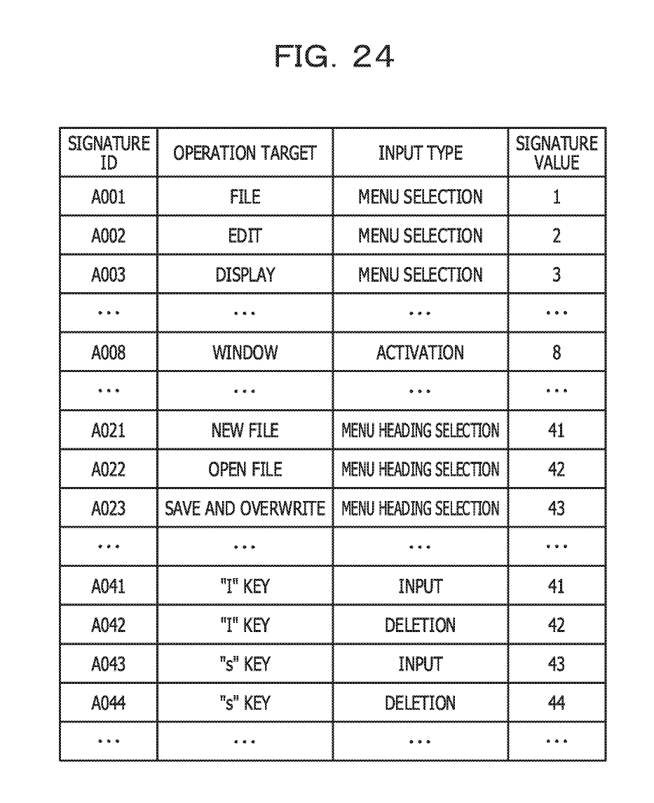

FIG. 24 is an explanatory diagram of a specific example of the second aggregated information 135b. The second aggregated information 135b illustrated in FIG. 24 includes, as a heading, “signature ID” which identifies each item of information contained in the second aggregated information 135b. More headings included in the second aggregated information 135b illustrated in FIG. 24 are “operation target” which identifies the operation target corresponding to the information which is input, “input type” which identifies the type of the information which is input, and “signature value” corresponding to the information of “signature ID”.

Specifically, in the second aggregated information 135b illustrated in FIG. 24, in the information in which “signature ID” is “A001”, “operation target” is set to “file”, and “input type” is set to “menu selection”. In the second aggregated information 135b illustrated in FIG. 24, in the information in which “signature ID” is “A001”, “signature value” is set to “1”. Hereinafter, description will be given of a specific example of a case in which the information that is set in “signature ID” in the second work identification information 132b is determined.

For example, in a case in which, of the second work identification information 132b illustrated in FIG. 23, the information to be set in “operation target” and “input type” is determined, the work identification information creation section 112 refers to the second aggregated information 135b illustrated in FIG. 24. The work identification information creation section 112 specifies information containing information that is the same as the information to be set in “operation target” and “input type” of the second work identification information 132b illustrated in FIG. 23, of the second aggregated information 135b.

Specifically, in the second work identification information 132b illustrated in FIG. 23, in the information in which “data ID” is “1”, “operation target” is set to “file”, and “input type” is set to “menu selection”.

In this case, the work identification information creation section 112 specifies the information from the second aggregated information 135b illustrated in FIG. 24 in which the information that is set in “operation target” is “file”, the information that is set in “input type” is “menu selection”, and “signature ID” is “A001”. Therefore, in this case, the work identification information creation section 112 sets “signature ID” of the information in which “data ID” of the second work identification information 132b is “1” to “A001”.

Specific Examples of Determining Information set in “Bit String”

Next, description will be given of specific examples of determining the bit string to be set in “bit string” of the second work identification information 132b illustrated in FIG. 23.

For example, as illustrated in FIG. 23, in a case in which the information that is set in “signature ID” in the second work identification information 132b is determined to be “A001”, the work identification information creation section 112 refers to the second aggregated information 135b and acquires “1” which is the information that is set in “signature value” of the information in which “signature ID” is “A001”.

Next, in the same manner as in the case described in FIG. 20, the work identification information creation section 112 associates the information which is set in the acquired “signature value” by referring to the second aggregated information 135b with the information which is set in “occurrence time” of the second work identification information 132b.

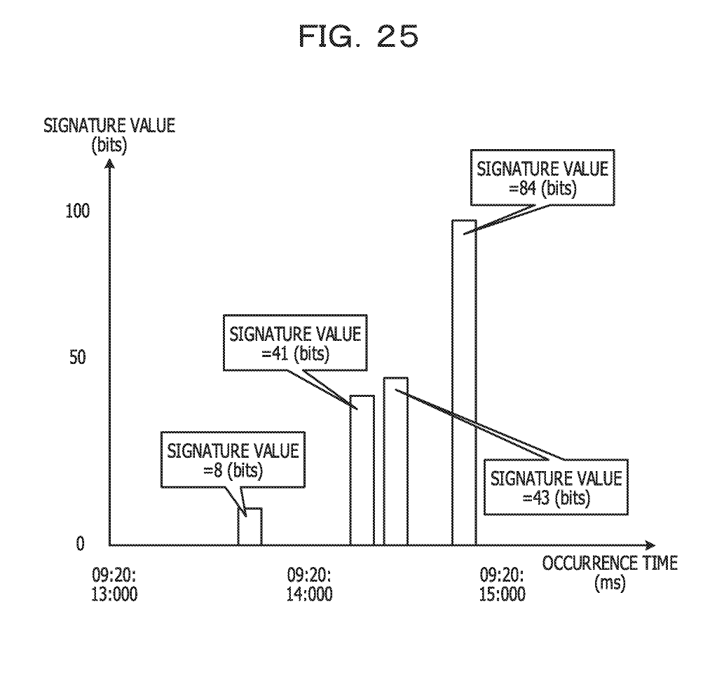

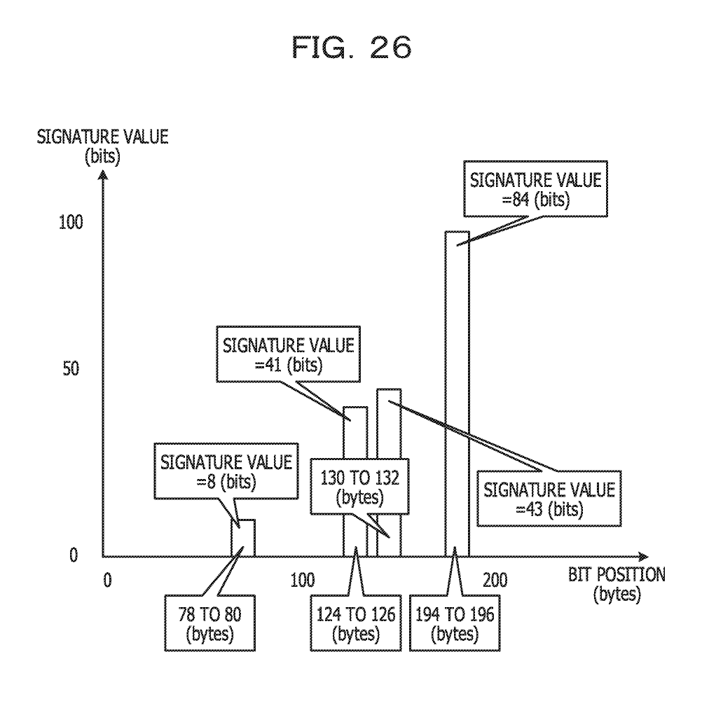

FIGS. 25 and 26 are graphs determining the bit strings that are set in “bit string” of the second work identification information 132b. FIG. 25 is a graph of a case in which the information which is set to “occurrence time” of the second work identification information 132b is set to the horizontal axis, and the information which is set to “signature value” which is acquired by referring to the second aggregated information 135b is set to the vertical axis. Hereinafter, description will be given of the information in which “work ID” is “S002” in the second work identification information 132b.

Specifically, “occurrence time” of the information in which “data ID” is “3” in the second work identification information 132b is “09:20:13:797”. The “signature ID” of the information in which “data ID” is “3” in the second work identification information 132b is “A008”, and “signature value” of the information in which the “signature ID” is “A008” in the second aggregated information 135b is “8”.

Therefore, in this case, as illustrated in FIG. 25, the work identification information creation section 112 sets the specifiable information to a position in which the horizontal axis is “09:20:13:797” and the vertical axis is “8 (bits)”. Description of the other information of FIG. 25 will be omitted.

In the same manner as the case described in FIG. 21, the work identification information creation section 112 replaces the horizontal axis in FIG. 25 with information indicating bit positions. In this case, as illustrated in FIG. 26, “09:20:13:797”, which is “occurrence time” of in the second work identification information 132b, is included between “09:20:13:780” and “09:20:13:800”. The value “09:20:13:780” on the horizontal axis of the graph of FIG. 25 corresponds to “78 (bytes)” on the horizontal axis of the graph of FIG. 26, and “09:20:13:800” on the horizontal axis of the graph of FIG. 25 corresponds to “80 (bytes)” on the horizontal axis of the graph of FIG. 26. Therefore, the work identification information creation section 112 determines that “8” which is the “signature value” of the information in which “signature ID” is “A008” in the second aggregated information 135b corresponds to “78 (bytes)” to “80 (bytes)” in the bit string.

In the same manner as the case described in FIG. 22, the work identification information creation section 112 creates the bit string based on the information contained in the graph illustrated in FIG. 26.

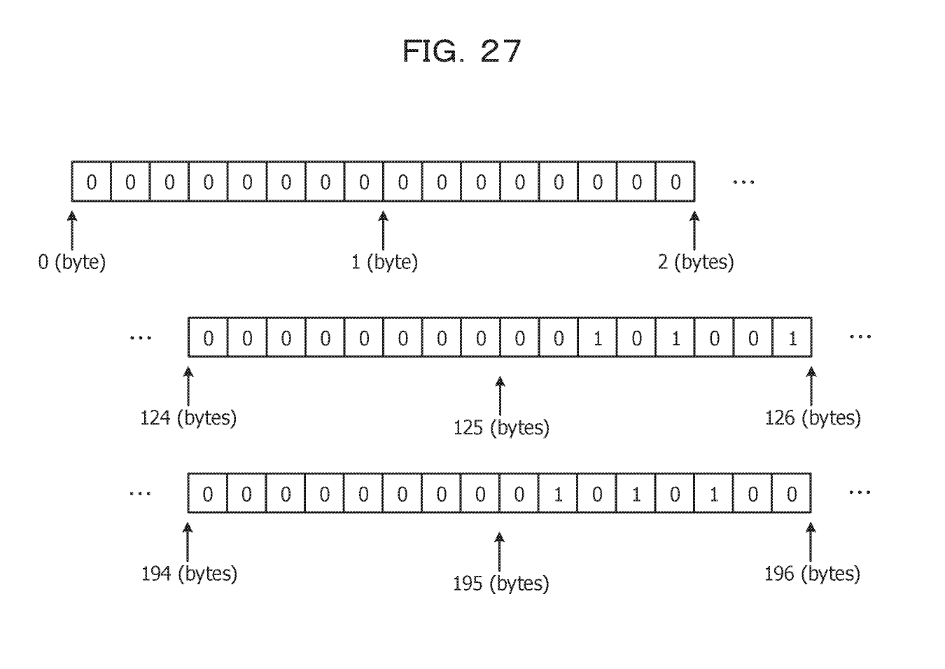

FIG. 27 is an explanatory diagram of a specific example of the bit string corresponding to the second work identification information 132b. For example, the work identification information creation section 112 sets “0000000000101001”, which is “41” in binary notation, at bit positions in the bit string illustrated in FIG. 27 from 124 (bytes) to 126 (bytes) (the information in which “data ID” is “4” in FIG. 23). For example, the work identification information creation section 112 sets “0000000001010100”, which is “84” in binary notation, at bit positions in the bit string illustrated in FIG. 27 from 194 (bytes) to 196 (bytes) (the information in which “data ID” is “6” in FIG. 23). Description of the cases in which the other information contained in FIG. 26 is set in the bit string of FIG. 27 will be omitted.

Specific Examples of Third Work Identification Information 132c

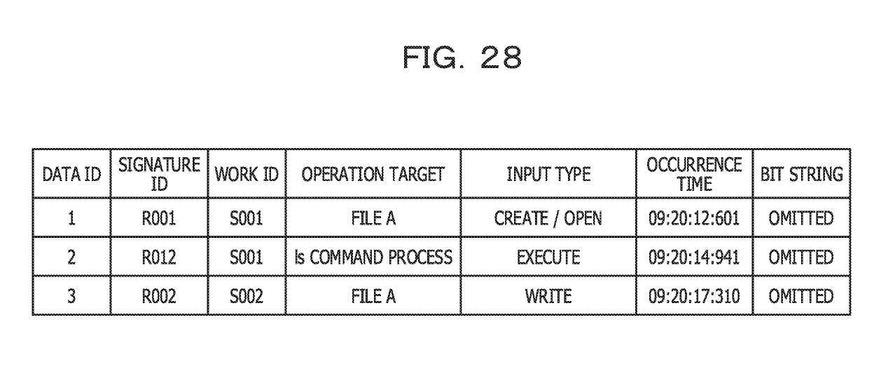

Next, description will be given of specific examples of the third work identification information 132c. FIG. 28 is an explanatory diagram of specific examples of the third work identification information 132c. The third work identification information 132c illustrated in FIG. 28 is information which is created based on the information contained in the third events which are described in FIG. 14.

The third work identification information 132c illustrated in FIG. 28 has the same headings as the second work identification information 132b described in FIG. 23. Specifically, in the third work identification information 132c illustrated in FIG. 28, in the information in which “data ID” is “1”, “signature ID” is set to “R001”, and “work ID” is set to “S001”. In the third work identification information 132c illustrated in FIG. 28, in the information in which “data ID” is “1”, “operation target” is set to “file A”, and “input type” is set to “create/open”. In the third work identification information 132c illustrated in FIG. 28, in the information in which “data ID” is “1”, “occurrence time” is set to “09:20:12:601”.

Note that, description of specific examples of cases in which the information to be set in “signature ID” and the information to be set in “bit string” of the third work identification information 132c of FIG. 28 is determined will be omitted.

Returning to FIG. 8, the work identification information creation section 112 accumulates the first work identification information 132a, the second work identification information 132b, and the third work identification information 132c which are created in S23 in the information storage region 130 (S24). In other words, the work identification information creation section 112 stores the work identification information 132 corresponding to the features (information which is input via the worker terminal 2) of works by a normal worker in the information storage region 130 before the first work is performed. Accordingly, as described later, it becomes possible for the abnormality detection section 114 and the coincidence calculation section 115 to determine whether or not to determine that a first work is abnormal in a case in which the first work is performed.

Note that, the work identification information creation section 112 may further create the feature point information 136 in which each item of information set in “bit string” of the first work identification information 132a, the second work identification information 132b, and the third work identification information 132c is associated with every work. Accordingly, in a case in which a first work is performed, as described later, it becomes possible for the abnormality detection section 114 and the coincidence calculation section 115 to determine whether or not to determine that the first work is abnormal without referring to each of the first work identification information 132a, the second work identification information 132b, and the third work identification information 132c. Hereinafter, description will be given of specific examples of the feature point information 136.

Specific Examples of Feature Point Information 136

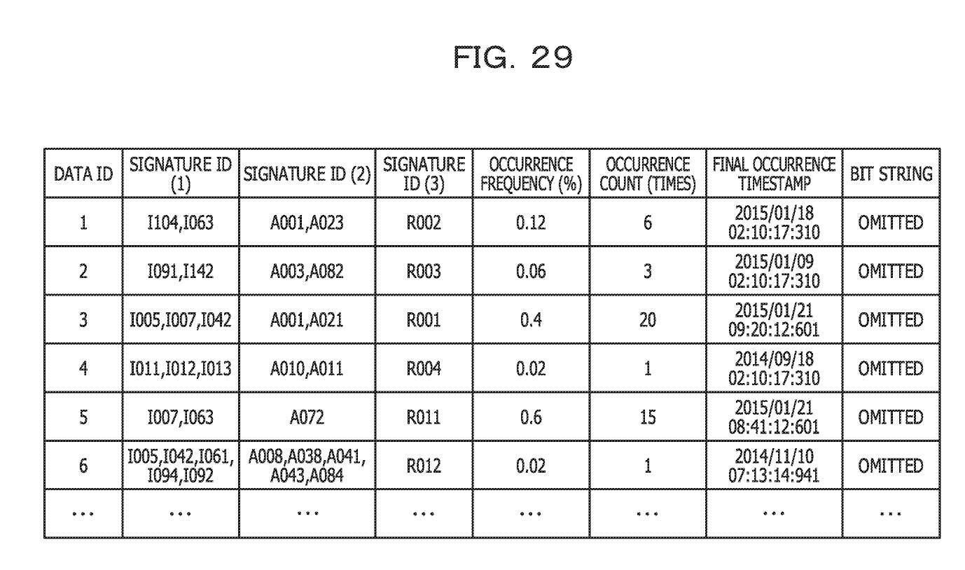

FIG. 29 is an explanatory diagram of specific examples of the feature point information 136. The feature point information 136 illustrated in FIG. 29 includes, as headings, “data ID” which identifies each item of information contained in the feature point information 136, “signature ID (1)” corresponding to “signature ID” of the first work identification information 132a, and “signature ID (2)” corresponding to “signature ID” of the second work identification information 132b. More headings included in the feature point information 136 illustrated in FIG. 29 are “signature ID (3)” corresponding to “signature ID” of the third work identification information 133c, “occurrence frequency” indicating the occurrence frequency of each item of information contained in the feature point information 136, and “occurrence count” indicating a cumulative occurrence count (creation count) of each item of information.

The feature point information 136 illustrated in FIG. 29 also includes, as headings, “final occurrence timestamp” indicating the timestamp at which the work corresponding to each item of information occurs, and “threshold information” indicating a permissible threshold of the difference in the compared information. The feature point information 136 illustrated in FIG. 29 includes “bit string” in which information obtained by concatenating the bit strings which are set to each “bit string” of the first work identification information 132a, the second work identification information 132b, and the third work identification information 132c is set.

Note that, the unit of “occurrence frequency” and “threshold information” is percent (%), for example. The “threshold information” in the feature point information 136 of FIG. 29 may correspond to the threshold information 134 described above.

Specifically, in the feature point information 136 illustrated in FIG. 29, in the information in which “data ID” is “1”, “signature ID (1)” is set to “I104, I063”, and “signature ID (2)” is set to “A001, A023”. In the feature point information 136 illustrated in FIG. 29, in the information in which “data ID” is “1”, “signature ID (3)” is set to “R002”, and “occurrence frequency” is set to “0.12 (%)”.

In the information in which “data ID” is “1”, “occurrence count” is set to “6”, “final occurrence timestamp” is set to “2015/01/18 02:10:17:310”, and “threshold information” is set to “90 (%)”. Information (a bit string) obtained by concatenating the information that is set in “bit string” of the information in which “data ID” is “1” in the first work identification information 132a of FIG. 18, the second work identification information 132b of FIG. 23, and the third work identification information 132c of FIG. 28 is set as “bit string”.

In other words, this indicates that the information in which “data ID” is “1” in the feature point information 136 illustrated in FIG. 29 corresponds to the information in which “work ID” is “S003” in each of the first work identification information 132a, the second work identification information 132b, and the third work identification information 132c. Specifically, this indicates that the information in which “data ID” is “1” in the feature point information 136 illustrated in FIG. 29 corresponds to the information in which “data ID” is “9” and “10” in the first work identification information 132a, and “data ID” is “7” and “8” in the second work identification information 132b. Further, this indicates that the information in which “data ID” is “1” in the feature point information 136 illustrated in FIG. 29 corresponds to information in which “data ID” is “3” in the third work identification information 132c.

Process During Determination of whether or not to Determine First Work Abnormal

Next, description will be given of the process during the determination of whether or not to determine that the first work is abnormal. Note that, hereinafter, the correspondence information which is created when the first work is performed will also be referred to as correspondence information 231. Hereinafter, the new work identification information which is created when the first work is performed will also be referred to as work identification information 232 (first work identification information 232a, second work identification information 232b, and third work identification information 232c).

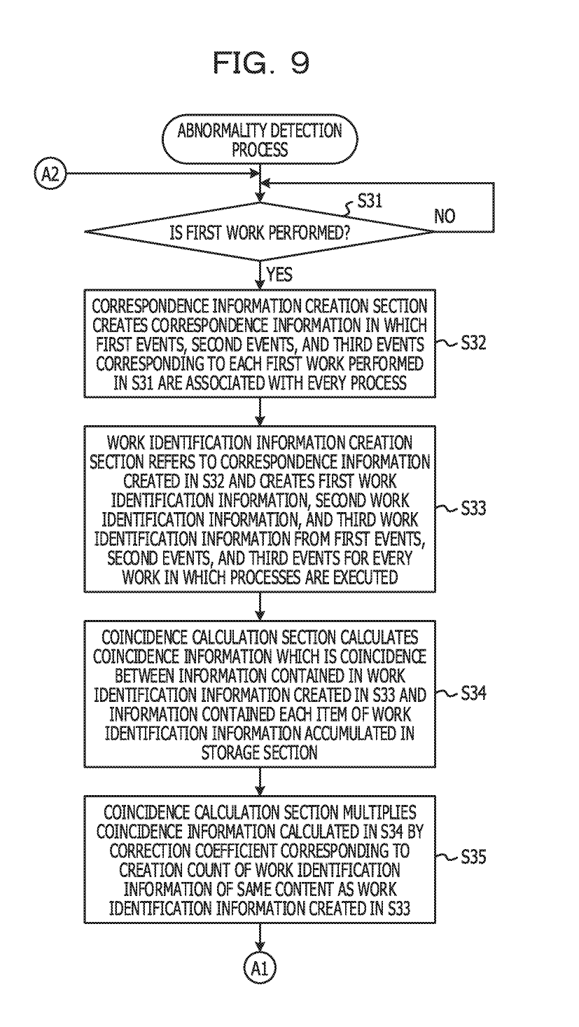

As illustrated in FIG. 9, the correspondence information creation section 111 waits until the first work is performed (NO in S31). In a case in which the first work is performed (YES in S31), the correspondence information creation section 111 creates the correspondence information 231 in the same manner as the process of S22 of FIG. 8 (S32). Subsequently, in the same manner as the process of S23 of FIG. 8, the correspondence information creation section 111 refers to the correspondence information 231 which is created in S32 and creates the first work identification information 232a, the second work identification information 232b, and the third work identification information 232c (S33).

In other words, as described later, the abnormality detection section 114 and the coincidence calculation section 115 determine whether or not to determine that the first work is abnormal by performing a comparison between the work identification information 232 based on the events which occur due to the first work being performed, and the work identification information 132 which is stored in the information storage region 130. Therefore, in the same manner as in the case described in FIG. 8, the correspondence information creation section 111 and the work identification information creation section 112 create the work identification information 232 from the events which occur due to the first work being performed.

Next, the coincidence calculation section 115 of the information processing device 1 calculates the coincidence information 133 which is the coincidence between the information contained in the work identification information 232 which is created in S33 and the information contained in the work identification information 132 which is accumulated in the information storage region 130 (S34).

Specifically, the coincidence calculation section 115 acquires “signature ID” contained in each of the first work identification information 232a, the second work identification information 232b, and the third work identification information 232c which are created in S33, for example. The coincidence calculation section 115 refers to the feature point information 136 illustrated in FIG. 29, for example, and determines whether or not information containing all of the acquired “signature IDs” is present in the feature point information 136. As a result, in a case in which the information containing all of the acquired “signature IDs” is not present in the feature point information 136, the coincidence calculation section 115 calculates the coincidence information 133 to be “0 (%)”.

Meanwhile, in a case in which the information containing all of the acquired “signature IDs” is present, the coincidence calculation section 115 acquires the bit strings which are set in “bit string” contained in each of the first work identification information 232a, the second work identification information 232b, and the third work identification information 232c which are created in S33, for example. The coincidence calculation section 115 concatenates each acquired bit string (hereinafter, the concatenated bit strings will also be referred to as a first bit string). In this case, the coincidence calculation section 115 acquires the bit string (hereinafter, also referred to as a second bit string) which is set in “bit string” contained in the information which is present in the feature point information 136, for example. The coincidence calculation section 115 calculates the coincidence information 133 (for example 80 (%)) which is a proportion of bits in which the information matches by performing a comparison between the first bit string and the second bit string, for example.

Accordingly, it becomes possible for the coincidence calculation section 115 to calculate the coincidence information 133 used for determining whether or not it is preferable for the abnormality detection section 114 to determine that the first work is abnormal by only performing a comparison of the bit strings contained in each item of information. Therefore, it becomes possible for the abnormality detection section 114 and the coincidence calculation section 115 to swiftly determine whether or not to determine that the first work is abnormal.

Note that, when acquiring the second bit string, the coincidence calculation section 115 may acquire the bit strings which are set in “bit string” contained in each of the first work identification information 132a, the second work identification information 132b, and the third work identification information 132c, and may concatenate the acquired bit strings. The information management section 113 may store the coincidence information 133 which is calculated in S34 in the information storage region 130.

Next, as illustrated in FIG. 9, the coincidence calculation section 115 multiplies the coincidence information 133 which is calculated in S34 by the correction coefficient information 137 corresponding to the occurrence count of the work identification information 132 of the same content as the work identification information 232 which is created in S33 (S35). Hereinafter, description will be given of specific examples of the correction coefficient information 137. Note that, hereinafter, the result obtained by multiplying the coincidence information 133 by the correction coefficient information 137 will also be referred to as a second value.

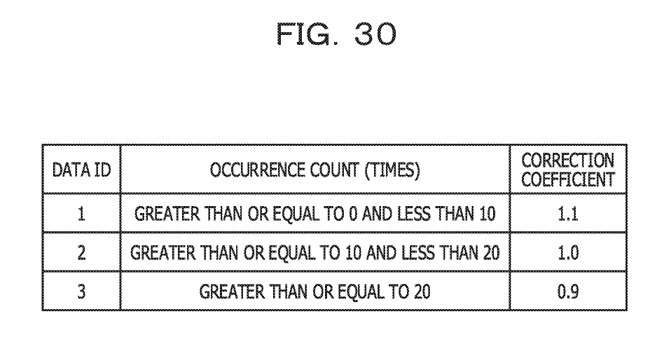

FIG. 30 is an explanatory diagram of specific examples of correction coefficient information 137. The correction coefficient information 137 illustrated in FIG. 30 includes, as headings, “data ID” which identifies each item of information contained in the correction coefficient information 137, “occurrence count” indicating the range of the occurrence count, and “correction coefficient” in which a correction coefficient corresponding to the occurrence count is set.

Specifically, in the correction coefficient information 137 illustrated in FIG. 30, in the information in which “data ID” is “1”, “occurrence count” is set to “0 (times) or more and less than 10 (times)”, and “correction coefficient” is set to “1.1”. In the correction coefficient information 137 illustrated in FIG. 30, in the information in which “data ID” is “2”, “occurrence count” is set to “10 (times) or more and less than 20 (times)”, and “correction coefficient” is set to “1.0”. In the correction coefficient information 137 illustrated in FIG. 30, in the information in which “data ID” is “3”, “occurrence count” is set to “20 (times) or more, and “correction coefficient” is set to “0.9”.

In other words, by using the correction coefficient information 137, it becomes possible for the coincidence calculation section 115 to perform the calculation of the coincidence information 133 in a form that reflects the occurrence count of the work identification information of the same content as the work identification information 232 which is created in S33. Therefore, for example, it becomes possible for the coincidence calculation section 115 to perform adjustments such as suppression of the value of the coincidence information 133 which is calculated in S34 more the greater the occurrence count of the work identification information of the same content as the work identification information 232 which is created in S33. Hereinafter, description of a specific example of a case in which the work identification information 232 which is created in S33 corresponds to the information in which “data ID” is “3” in the feature point information 136 of FIG. 29, and the coincidence information 133 which is calculated in S34 is 80 (%).

In this case, the coincidence calculation section 115 acquires “20” which is the information that is set in “occurrence count” of the information in which “data ID” is “3” in the feature point information 136 of FIG. 29. The coincidence calculation section 115 refers to the correction coefficient information 137 of FIG. 30 and acquires “0.9” which is “correction coefficient” of the information in which “occurrence count” is “20”. Subsequently, the coincidence calculation section 115 calculates 72 (%) which is obtained by multiplying 80 (%) which is the coincidence information 133 which is calculated in S34 by “0.9” (S35). Accordingly, it becomes possible for the coincidence calculation section 115 to calculate the coincidence information 133 in a form that reflects the content of the correction coefficient information 137. Note that, the information management section 113 may store the coincidence information 133 which is calculated in S35 in the information storage region 130.

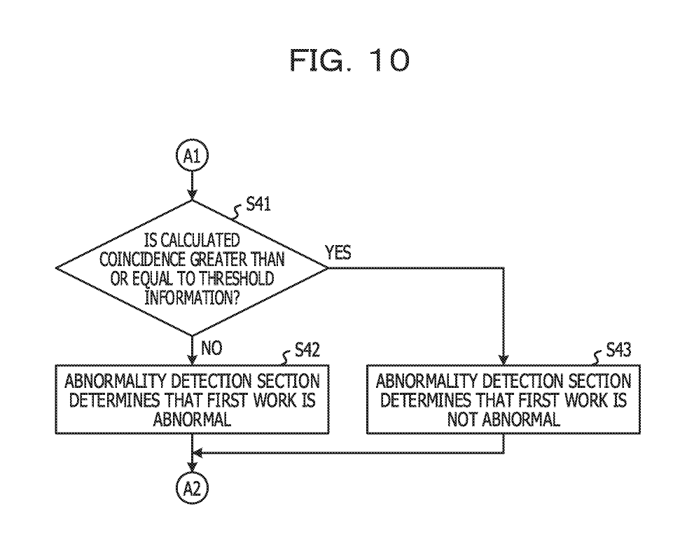

Returning to FIG. 10, the abnormality detection section 114 determines whether or not the coincidence information 133 which is calculated in S35 is greater than or equal to the threshold information 134 which is stored in the information storage region 130 (S41). As a result, in a case in which it is determined that the coincidence information 133 which is calculated in S35 is less than the threshold information 134 (NO in S41), the abnormality detection section 114 determines that the first work is abnormal (S42). Meanwhile, in a case in which it is determined that the coincidence information 133 which is calculated in S35 is greater than or equal to the threshold information 134 (YES in S41), the abnormality detection section 114 determines that the first work is not abnormal (S43).

Specifically, the abnormality detection section 114 acquires “90 (%)” which is the information that is set in “threshold information” of the information in which “data ID” is “3” in the feature point information 136 of FIG. 29, for example. For example, in a case in which the coincidence information 133 which is calculated in S35 is 72 (%), since the coincidence information 133 which is calculated in S35 is less than 90(%) which is the information that is set in “threshold information”, the abnormality detection section 114 determines that the first work is abnormal (NO in S41, S42).

Note that, in a case in which information including all “signature IDs” of the first work identification information 232a, the second work identification information 232b, and the third work identification information 232c is present in the feature point information 136, for example, the information management section 113 may increase “occurrence count” of the information in which the feature point information 136 is present. In this case, the information management section 113 may increase the information that is set in “occurrence count” of the feature point information 136 limited to a case in which the abnormality detection section 114 determines that the first work is not abnormal (YES in S41, S43).

The coincidence calculation section 115 may perform the comparison of the first bit string with all of the bit strings contained in the feature point information 136 illustrated in FIG. 29 and calculate the coincidence information 133 of each (S34). In this case, the abnormality detection section 114 may determine that the first work is not abnormal in a case in which information which is greater than or equal to the threshold information 134 is present in the calculated coincidence information 133 (YES in S41, S43). Meanwhile, the abnormality detection section 114 may determine that the first work is abnormal in a case in which information which is greater than or equal to the threshold information 134 is not present in the calculated coincidence information 133 (NO in S41, S42).

Process During Updating of Threshold Information 134

Next, description will be given of the process (hereinafter also referred to as the threshold information update process) which is executed when updating the threshold information 134. The threshold information creation section 116 of the information processing device 1 waits until the threshold information creation timing is reached (NO in S51). The threshold information creation timing may be a regular timing such as once per week, for example.

Subsequently, in a case in which the threshold information creation timing is reached (YES in S51), the threshold information creation section 116 refers to the feature point information 136 which is accumulated in the information storage region 130 (S52). Specifically, the threshold information creation section 116 refers to the information that is set in “final occurrence timestamp” contained in the feature point information 136 illustrated in FIG. 29, for example.

The threshold information creation section 116 determines whether or not the information that is set in “final occurrence timestamp” is earlier than a predetermined timestamp (S53). In other words, the threshold information creation section 116 determines whether or not the timestamp (hereinafter also referred to as the first timestamp) at which the work identification information 232 corresponding to each item of information contained in the feature point information 136 is previously generated is earlier than a predetermined timestamp. As a result, in a case in which the information that is set in “final occurrence timestamp” is earlier than the predetermined timestamp (YES in S53), the threshold information creation section 116 determines the information to be set in “threshold information” of the feature point information 136 which is referenced in S52 to be the first threshold (S54). Meanwhile, in a case in which the information that is set in “final occurrence timestamp” is later than the predetermined timestamp (NO in S53), the threshold information creation section 116 determines the information to be set in “threshold information” of the feature point information 136 which is referenced in S52 to be the second threshold which is a higher value than the first threshold (S55).

In other words, the threshold information creation section 116 performs adjustment of the value that is set in the feature point information 136 based on the features of the work which the worker performs on the information processing device 1. Accordingly, it becomes possible for the information processing device 1 to determine whether or not to determine that the first work is abnormal in a form that reflects the occurrence state of each work.

Specifically, in a case in which the present timestamp is 0:00, Apr. 1, 2015 and the predetermined timestamp is “3 months earlier than the present timestamp”, the “final occurrence timestamp” of the information in which “data ID” is “4” and “6” in the feature point information illustrated in FIG. 29 is set to a timestamp which is earlier than the predetermined timestamp. Therefore, in this case, the threshold information creation section 116 determines the information to be set in “threshold information” of the information in which “data ID” is “4” and “6” among the feature point information illustrated in FIG. 29 to be the first threshold (S54). Meanwhile, in this case, in “final occurrence timestamp” of the information in which “data ID” is “1”, “2”, “3”, and “5” among the feature point information illustrated in FIG. 29, a timestamp later than the predetermined timestamp is set. Therefore, the threshold information creation section 116 determines the information to be set in “threshold information” of the information in which “data ID” is “1”, “2”, “3”, and “5” among the feature point information illustrated in FIG. 29 to be the second threshold (S55).

Therefore, in the example indicated by the feature point information 136 of FIG. 29, for example, in a case in which the first threshold is 80 (%) and the second threshold is 90 (%), the threshold information creation section 116 updates “threshold information” of the information in which “data ID” is “4” from 90 (%) to 80 (%).

In a case in which the acquisition of all the information contained in all of the feature point information 136 has not been performed (NO in S56), the threshold information creation section 116 executes the processes of S52 onward again. Meanwhile, in a case in which the acquisition of all the information contained in the feature point information 136 is completed (YES in S56), the threshold information creation section 116 ends the threshold information update process.

In this manner, according to the first embodiment, the information processing device 1 creates the correspondence information 131 in which the events that occur accompanying the execution of the plurality of processes which are executed on the information processing device 1 are associated with every process based on the access information in relation to the system resources of the information processing device 1. The information processing device 1 refers to the correspondence information 131, creates the work identification information 132 which identifies each work from the events that are associated with the processes corresponding to each work for every work in which processes are executed, and accumulates the work identification information 132 in the information storage region 130.

Subsequently, in a case in which the first work for executing the first process that is executed on the information processing device 1 is performed, the information processing device 1 determines that the first work is abnormal in a case in which the new work identification information that is created from the first work is different from the work identification information 132 which is accumulated.

Accordingly, it becomes possible for the information processing device 1 to perform detection of works which may be abnormal works among the first works which are performed on the information processing device 1. It becomes possible for the worker to perform a detailed investigation of the detected works, for example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable storage medium which stores an abnormality detection program causes a computer to execute processes comprising:
detecting, when a work corresponding to a process on the computer has been executed, at least one event that is associated with the process on the computer, the at least one event including at least one first event which respectively occurs in response to at least one input for the process by using the input device; and
determining whether the work is abnormal or not based on whether the at least one detected event matches at least one stored event in a storage unit or not.

2. The computer-readable storage medium according to claim 1, wherein the processes further comprises:
generating, when a worker executes the work, correspondence information that associates the at least one process with the at least one event based on access information relating to system resources of the computer, the worker being permitted to execute works on the computer;
generating identification information for the determining based on the correspondence information, the identification information including a process identifier that identifies at least one process corresponding to the work and event identifier that identifies at least one event corresponding to the at least one process corresponding to the work; and
storing the generated identification information in the storage unit.

3. The computer-readable storage medium according to claim 2, wherein the processes further comprises:
generating another identification information based on the at least one detected event; and
determining, in the determining, that the work is abnormal in a case in which the another identification information is different from the identification information that are stored in the storage unit and that corresponds to the work.

4. The computer-readable storage medium according to claim 2, wherein
wherein the system resources include an input device, an application which operates on the computer, and an operating system which operates on the computer, wherein
the at least one event further includes a second event which respectively occurs in response to an occurrence of access to the application and a third event which respectively occurs in response to an occurrence of access to the operating system, and wherein
the identification information includes first work identification information which is generated based on the first event, second work identification information which is generated based on the second event, and third work identification information which is generated based on the third event.

5. The computer-readable storage medium according to claim 2, wherein the processes further comprising:
calculating a first value which indicates a coincidence between a combination of the another identification information and the identification information stored in the storage unit; and
determining that the first work is abnormal when the calculated first value indicates less coincidence than a first predetermined threshold.

6. The computer-readable storage medium according to claim 5, wherein the processes comprising:
calculating a second value, the second value being calculated by multiplying the first value by a correction coefficient corresponding to a number of times that the combination has been specified in past times, and
determining that the work is abnormal when the calculated second value indicates less coincidence than a second predetermined threshold.

7. The computer-readable storage medium according to claim 5, wherein the processes comprising:
determining, in a case in which a first timestamp at which same combination as the combination is previously specified is earlier than a predetermined timestamp, a lower value than in a case in which the first timestamp is later than the predetermined timestamp as the first predetermined threshold.

8. The computer-readable storage medium according to claim 2,
wherein the information contained in the identification information is a bit string which is converted based on predetermined rules.

9. An abnormality detection device, comprising:
a memory; and
a processor configured to:
detect, when a work corresponding to a process on the computer has been executed, at least one event that is associated with the process on the computer, the at least one event including at least one first event which respectively occurs in response to at least one input for the process by using the input device; and
determine whether the work is abnormal or not based on whether the at least one detected event matches at least one stored event in a storage unit or not.

10. An abnormality detection method in which processes are executed by a computer, the method comprising:
detecting, when a work corresponding to a process on the computer has been executed, at least one event that is associated with the process on the computer, the at least one event including at least one first event which respectively occurs in response to at least one input for the process by using the input device; and
determining whether the work is abnormal or not based on whether the at least one detected event matches at least one stored event in a storage unit or not.
